(19) United States
(12) Patent Application Publication
(10) Pub. No.: US 2016/0029224 A1
(43) Pub. Date: Jan. 28, 2016

(54) DETERMINATION OF ENVIRONMENT CHARACTERISTICS FROM MOBILE DEVICE-BASED SENSOR MEASUREMENTS

(71) Applicant: QUALCOMM Incorporated, San Diego, CA (US)

(72) Inventor: Stephen William EDGE, Escondido, CA (US)

(21) Appl. No.: 14/805,819

(22) Filed: Jul. 22, 2015

Related U.S. Application Data
(60) Provisional application No. 62/028,221, filed on Jul. 23, 2014.

(51) Int. Cl. H04W 16/18; H04W 24/08; G01S 5/02; H04W 4/02

(52) U.S. Cl. CPC H04W 16/18; H04W 4/02; H04W 24/08; G01S 5/0252

(57) ABSTRACT

Disclosed are methods, devices, systems, apparatus, processor-readable media, and other implementations, including a method that comprises receiving from multiple mobile devices, at a processor-based server, measurement data representative of sensor measurements performed by at least one sensor of each of the multiple mobile devices, and determining environmental characteristics associated with one or more environments at which each of the multiple mobile devices are located based on one or more environmental rules applied to the measurement data received from the multiple mobile devices. Also disclosed are methods, devices, systems, apparatus, processor-readable media for determining environmental rules based on sensor measurements provided by mobile devices for known locations or known environments.

### CLAIM OF PRIORITY UNDER 35 U.S.C. §119

The present application claims the benefit of and priority to U.S. Provisional Application Ser. No. 62/028,221, entitled “DETERMINATION OF ENVIRONMENT CHARACTERISTICS FROM MOBILE DEVICE-BASED SENSOR MEASUREMENTS,” filed Jul. 23, 2014, which is assigned to the assignee hereof, and expressly incorporated herein by reference.

### BACKGROUND

Wireless communication networks using second, third and fourth generation wireless technologies (sometimes referred to as 2G, 3G and 4G, respectively) are now deployed all over the World, permitting wireless voice and data communication between mobile devices (e.g. cellphones, laptops, tablets, smartphones) and between mobile devices and fixed devices (e.g. telephones, web servers, computing platforms etc.). Wireless communication networks may serve a wide area (e.g. employing cellular base stations supporting macro, pico and small cells), a medium (e.g. metropolitan) area or a small area (e.g. employing access points with limited radio coverage).

In order to enable an operator of one or more wireless networks to gather information on network coverage and improve network service, crowdsourcing may be employed. Crowdsourcing may comprise the collection of data from multiple contributing mobile devices (e.g. mobile devices belonging to users subscribed to an operator who is performing the crowdsourcing). The crowdsourced data may enable mapping of RF conditions (e.g., Received Signal Strength Indication (RSSI) and/or Round Trip signal propagation Time (RTT) for visible base stations and/or WiFi Access Points (APs) belonging to one or more operators) at different locations via aggregation of measurements from multiple terminals. This may enable service gaps to be identified (e.g. locations where few or no base stations or APs belonging to a particular operator are visible). The crowdsourced data may also or instead be used to improve support for location services by an operator or by some other service provider (e.g. a location services provider) by, for example, enabling the determination of base station almanac data that may include the approximate or exact locations of the base stations and APs for which crowdsourced data is provided, the identities of the cells these base stations and APs support and certain transmission characteristics for each cell (and/or for each base station or AP) such as transmission power, transmission or signal timing and supported wireless technologies. The crowdsourced data may also assist support of location services by enabling RF heat maps to be created (e.g., by a server) that each provide an RF characteristic or characteristics (e.g., mean RSSI, mean RTT, mean Signal to Noise ratio (S/N), etc.) for an individual cell, base station or access point at a number of different locations—for example at locations corresponding to a set grid of points spaced at, for example, one meter intervals from one another.

Since an operator or other service provider may invest significant resources in gathering crowdsourced data (e.g. resources to transfer the crowdsourced data to a server and to process and store it there), there may be a benefit to using crowdsourced data not only to improve network services and support location services but also for other purposes. One such other purpose may be to gather information on environmental characteristics (e.g. that may not be related to RF characteristics) at different locations in the coverage area of a particular operator or in the service area of some other service provider (e.g. a location service provider). The gathered environmental characteristics may assist the operator or other service provider to better provide existing services and/or to provide new services—e.g. by knowing when a served user may be indoors, outdoors, at an airport, in a shopping mall, etc. which may assist in positioning of a user, providing services related to a particular environment to a user and/or in evaluating and improving network coverage in particular environments. The gathered environmental characteristics may avoid the need for an operator or other service provider to access and make use of separate map or building information to gather similar information which may be an advantage when map or building information is not available, considered to be confidential, not yet created, out of date or otherwise time consuming or expensive to access and evaluate.

### SUMMARY

In some variations, an example method is disclosed. The method includes receiving from multiple mobile devices, at a processor-based server, measurement data representative of sensor measurements performed by at least one sensor of each of the multiple mobile devices, and determining environmental characteristics associated with one or more environments at which each of the multiple mobile devices are located based on one or more environmental rules applied to the measurement data received from the multiple mobile devices.

Embodiments of the method may include at least some of the features described in the present disclosure, including one or more of the following features.

The method may further include determining at least one of the one or more environmental rules based on previously acquired sensor measurement data representative of sensor measurements performed by at least one sensor of at least one mobile device, and based on known environmental characteristics associated with at least one location at which the sensor measurements by the at least one sensor of the at least one mobile device were performed.

The at least one of the one or more environmental rules may be determined based further on one or more of, for example, geographical information associated with the at least one location, and/or temporal information associated with a date and time at which the sensor measurements by the at least one sensor of the at least one mobile device were performed.

The measurement data may include one or more of, for example, barometric pressure data, temperature data, humidity data, mobile device motion state data, ambient sound level data, ambient illumination data, mobile device activation and deactivation data, and/or radio frequency (RF) measurement data.

Determining environmental characteristics may include computing candidate environmental characteristics and associated weights resulting from application of each of the one or more environmental rules to at least a portion of the measurement data, combining the candidate environmental characteristics based on the weights, and computing an environmental characteristic based on the combined candidate environmental characteristics.

Computing the weights may be based on a degree of fit between the measurement data and parameters defining the respective applied one or more environmental rules.

The method may further include partitioning an area of interest into a plurality of partitioned areas, obtaining local candidate environmental characteristics for each partitioned area of the plurality of partitioned areas based, at least in part, on measurement data representing sensor measurements performed by mobile devices while visiting each partitioned area, and determining a probable set of environmental characteristics for the plurality of partitioned areas based, at least in part, on at least one rule providing correlations between local candidate environmental characteristics in two or more nearby partitioned areas in the plurality of partitioned areas.

A respective size of each partitioned area from the plurality of partitioned areas may be adjusted to achieve an equal or similar number of mobile devices providing measurement data representing sensor measurements for each partitioned area.

The method may further include determining one or more categories of environmental characteristics for one or more locations visited by the multiple mobile devices based, at least in part, on one or more environmental category rules applied to the measurement data.

The method may further include determining one or more specific environments or specific environmental characteristics based at least in part on the determined categories of environmental characteristics.

The method may further include communicating, to at least one mobile device, navigation data determined based, at least in part, on at least one of the environmental characteristics determined from the measurement data, with the navigation data including one or more of, for example, map data for a particular environment, data for one or more environmental characteristics for the particular environment, or navigation instructions corresponding to the particular environment.

The method may further include selecting from a set of environmental rules, based, at least in part, on the measurement data, the one or more environmental rules to apply to the measurement data.

In some variations, a device is provided that includes one or more processors, and storage media comprising computer instructions. The computer instructions, when executed on the one or more processors, cause operations including receiving from multiple mobile devices, at the device, measurement data representative of sensor measurements performed by at least one sensor of each of the multiple mobile devices, and determining environmental characteristics associated with one or more environments at which each of the multiple mobile devices are located based on one or more environmental rules applied to the measurement data received from the multiple mobile devices.

Embodiments of the device may include at least some of the features described in the present disclosure, including at least some of the features described above in relation to the method.

In some variations, an apparatus is provided. The apparatus includes means for receiving from multiple mobile devices measurement data representative of sensor measurements performed by at least one sensor of each of the multiple mobile devices, and means for determining environmental characteristics associated with one or more environments at which each of the multiple mobile devices are located based on one or more environmental rules applied to the measurement data received from the multiple mobile devices.

Embodiments of the apparatus may include at least some of the features described in the present disclosure, including at least some of the features described above in relation to the method and the device.

In some variations, a processor-readable media programmed with a set of instructions executable on a processor is disclosed. The set of instructions, when executed, causes operations including receiving from multiple mobile devices, at a processor-based server, measurement data representative of sensor measurements performed by at least one sensor of each of the multiple mobile devices, and determining environmental characteristics associated with one or more environments at which each of the multiple mobile devices are located based on one or more environmental rules applied to the measurement data received from the multiple mobile devices.

Embodiments of the processor-readable media may include at least some of the features described in the present disclosure, including at least some of the features described above in relation to the method, the device, and the apparatus.

In some variations, an additional method is disclosed. The additional method includes obtaining from at least one sensor of a mobile device measurement data representative of sensor measurements performed by the at least one sensor of the mobile device, and transmitting to a remote processor-based device the measurement data. The remote processor-based device is configured to determine environmental characteristics, associated with an environment in which the mobile device is located, based on one or more environmental rules applied to the measurement data obtained from the mobile device.

Embodiments of the additional method may include at least some of the features described in the present disclosure, including at least some of the features described above in relation to the first method, the device, the apparatus, and the processor-readable media.

In some variations, a mobile device is provided that includes one or more processors, at least one sensor, at least one transceiver, and storage media comprising computer instructions. The computer instructions, when executed on the one or more processors, cause operations including obtaining from the at least one sensor of the mobile device measurement data representative of sensor measurements performed by the at least one sensor of the mobile device, and transmitting to a remote processor-based device the measurement data. The remote processor-based device is configured to determine environmental characteristics, associated with an environment in which the mobile device is located, based on one or more environmental rules applied to the measurement data obtained from the mobile device.

Embodiments of the mobile device may include at least some of the features described in the present disclosure, including at least some of the features described above in relation to the methods, the first device, the apparatus, and the processor-readable media.

In some variations, an additional apparatus is provided. The additional apparatus includes means for obtaining from at least one sensor of a mobile device measurement data representative of sensor measurements performed by the at least one sensor of the mobile device, and means for transmitting to a remote processor-based device the measurement data. The remote processor-based device is configured to determine environmental characteristics, associated with an environment in which the mobile device is located, based on one or more environmental rules applied to the measurement data obtained from the mobile device.

Embodiments of the additional apparatus may include at least some of the features described in the present disclosure, including at least some of the features described above in relation to the methods, the devices, the first apparatus, and the processor-readable media.

In some variations, additional processor-readable media programmed with a set of instructions executable on a processor is disclosed. The set of instructions, when executed, causes operations including obtaining from at least one sensor of a mobile device measurement data representative of sensor measurements performed by the at least one sensor of the mobile device, and transmitting to a remote processor-based device the measurement data. The remote processor-based device is configured to determine environmental characteristics, associated with an environment in which the mobile device is located, based on one or more environmental rules applied to the measurement data obtained from the mobile device.

Embodiments of the additional processor-readable media may include at least some of the features described in the present disclosure, including at least some of the features described above in relation to the methods, the devices, the apparatus, and the first processor-readable media.

In some variations, a further method is disclosed. The further method, performed at a processor-based device, includes receiving from multiple mobile devices measurement data representative of sensor measurements performed by at least one sensor of each of the multiple mobile devices, and determining environmental characteristics for one or more locations visited by the multiple mobile devices based, at least in part, on one or more environmental rules applied to the measurement data.

Embodiments of the further method may include at least some of the features described in the present disclosure, including at least some of the features described above in relation to the methods, the devices, the apparatus, and the processor-readable media, as well as one or more of the following features.

The method may further include, at the processor-based device, determining at least one of the one or more environmental rules based, at least in part, on previously acquired sensor measurement data representative of sensor measurements performed by at least one sensor of at least one mobile device, and on known environmental characteristics associated with at least one location at which the sensor measurements by the at least one sensor of the at least one mobile device were performed.

The at least one of the one or more environmental rules may be determined based further on one or more of, for example, geographical information associated with the at least one location, and/or temporal information associated with the date and time at which the sensor measurements by the at least one sensor of the at least one mobile device were performed.

The measurement data may include one or more of, for example, barometric pressure data, temperature data, humidity data, mobile device motion state data, ambient sound level data, ambient illumination data, mobile device activation and deactivation data, and/or radio frequency (RF) measurement data.

Determining environmental characteristics may include computing candidate environmental characteristics and associated weights resulting from application of each of the one or more environmental rules to at least a portion of the measurement data, combining the candidate environmental characteristics based on the weights, and computing an environmental characteristic based on the combined candidate environmental characteristics.

Computing the weights may be based on the degree of fit between the measurement data and parameters defining the respective applied one or more environmental rules.

The method may further include, at the processor-based device, partitioning an area of interest into a plurality of partitioned areas, obtaining local candidate environmental characteristics for each partitioned area of the plurality of partitioned areas based, at least in part, on measurement data representing sensor measurements performed by mobile devices while visiting each partitioned area, and determining a probable set of environmental characteristics for the plurality of partitioned areas based, at least in part, on at least one rule providing correlations between local candidate environmental characteristics in two or more nearby partitioned areas in the plurality of partitioned areas.

A respective size of each partitioned area from the plurality of partitioned areas may be adjusted to achieve an equal or similar number of mobile devices providing measurement data representing sensor measurements for each partitioned area.

The method may further include determining one or more categories of environmental characteristics for one or more locations visited by the multiple mobile devices based, at least in part, on one or more environmental category rules applied to the measurement data.

The method may further include determining one or more specific environments or specific environmental characteristics based at least in part on the determined categories of environmental characteristics.

The method may further include, at the processor-based device, communicating, to at least one mobile device, navigation data determined based, at least in part, on at least one of the environmental characteristics determined from the measurement data, with the navigation data including one or more of, for example, map data for a particular environment where the mobile device is located, data for one or more environmental characteristics for the particular environment, and/or navigation instructions to facilitate navigation of the mobile device.

The method may further include, at the processor-based device, selecting from a set of environmental rules, based, at least in part, on the measurement data, the one or more environmental rules to apply to the measurement data.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

As used herein, including in the claims, “or” or “and” as used in a list of items prefaced by “at least one of” or “one or more of” indicates that any combination of the listed items may be used. For example, a list of “at least one of A, B, or C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, or C” (or “one or more of A, B, or C”) may also include A, AA, AAB, AAA, BB, BCC, etc.

As used herein, including in the claims, unless otherwise stated, a statement that a function, operation, or feature, is “based on” an item and/or condition means that the function, operation, function is based on the stated item and/or condition and may be based on one or more other items and/or conditions in addition to the stated item and/or condition.

As used herein, a mobile device or mobile station (MS) refers to a device such as a cellular or other wireless communication device, a smartphone, tablet, personal communication system (PCS) device, personal navigation device (PND), Personal Information Manager (PIM), Personal Digital Assistant (PDA), laptop or other suitable mobile device which is capable of receiving and/or sending wireless communication and/or navigation signals, such as navigation positioning signals. The term “mobile station” (or “mobile device” or “wireless device”) is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, a “mobile station” is intended to include all devices, including wireless communication devices, computers, laptops, tablet devices, etc., which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.” A mobile device may also be referred to as a mobile terminal, a terminal, a user equipment (UE), a device, a Secure User Plane Location Enabled Terminal (SET), a target device, a target, a wireless device, a wireless terminal or by some other name.

As used herein, an access point (AP), node and base station are considered to be potentially synonymous and to be wireless transceivers that perform like functions of supporting transmission and reception of wireless signals to and from mobile devices. Although an AP typically refers to an entity with a short communication range (e.g. up to 100 meters) while a base station typically refers to an entity with a longer communication range (e.g. over 100 meters), the deployment of small cell base stations and non-cellular wireless technologies with longer range has blurred the distinction, leading to use of both terms synonymously herein.

As used herein, the terms location, position, location estimate, position estimate, location fix, position fix and fix refer synonymously to a geographic location (e.g. latitude, longitude and possibly altitude coordinates) or to a civic location (e.g. a street address, building or site name coupled possibly with additional detail like a designation of a portion of a building or site, a room, apartment or suite designation etc.).

Other and further objects, features, aspects, and advantages of the present disclosure will become better understood with the following detailed description of the accompanying drawings.

### BRIEF DESCRIPTION OF THE DRAWING

FIG. 1 is a schematic diagram of a system configured to implement environmental characteristics determination based on crowdsourced measurements data.

FIG. 2 is a signal flow diagram illustrating embodiments of the present invention.

FIG. 3 is a block diagram of an example mobile device.

FIG. 4 is a schematic diagram of an example server.

FIG. 5 is a flowchart of an example procedure for environmental characteristics determination.

FIG. 6 is a flowchart of an example procedure, generally performed at a mobile device, to facilitate environmental characteristics determination.

FIG. 7 is a schematic diagram of an example computing system.

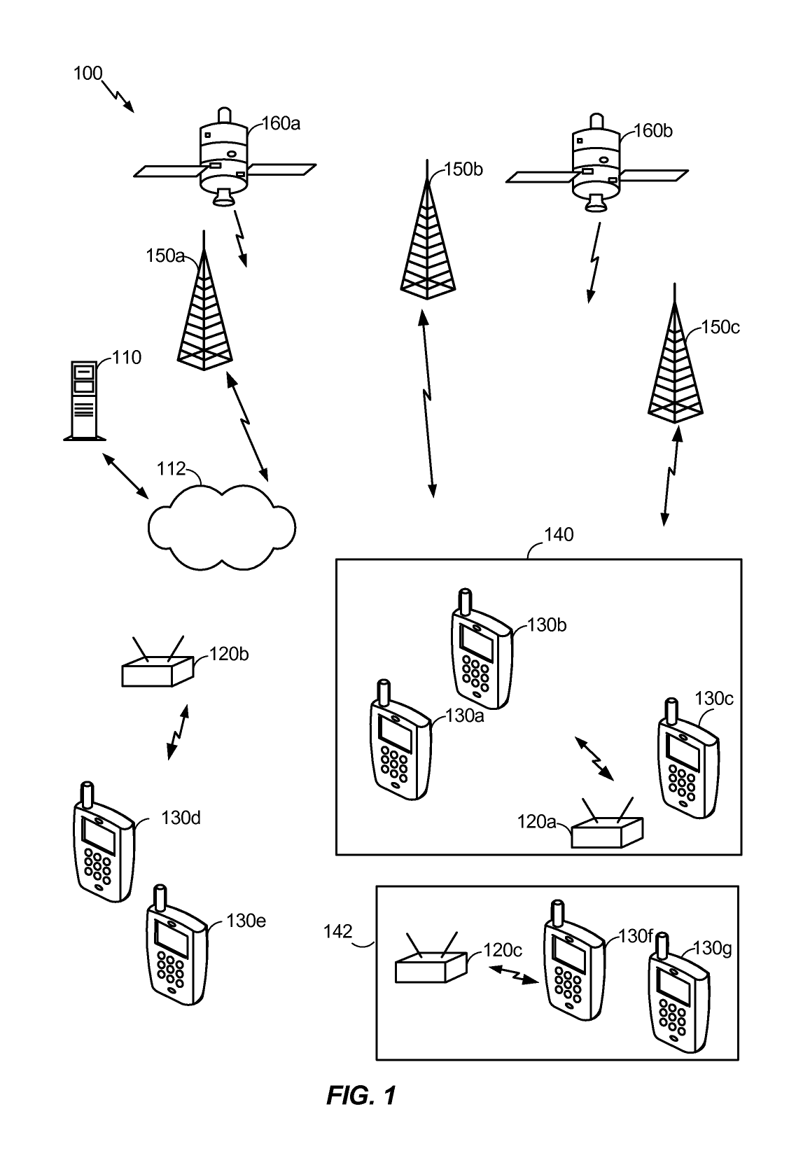

Like reference symbols and labels in the various drawings indicate like elements. Further, some labels in the various drawings identify an element using a numeric prefix followed by an alphabetic suffix. Reference to an element using just the numeric prefix in such cases should be interpreted as referring to any element with this numeric prefix. For example, a reference to one mobile device 130 in FIG. 1 means any one of the mobile devices 130a-g in FIG. 1, whereas a reference to mobile devices 130 (in the plural) in FIG. 1 means some or all of the mobile devices 130a-g in FIG. 1.

### DETAILED DESCRIPTION

Described herein are methods, systems, devices, computer readable media, and other implementations, including a method that includes receiving from multiple mobile devices, at a processor-based server (e.g., a location server, or any other type of server), measurement data representative of sensor measurements performed by at least one sensor (e.g., one or more of inertial/motion sensors, pressure sensors, humidity sensors, optical sensors, audio sensors, etc.) of each of the multiple mobile devices. The method further includes determining environmental characteristics for, or associated with, one or more environments visited by one or more of the multiple mobile devices based on one or more environmental rules applied to the measurement data. In some embodiments, the measurement data received at the processor-based server may include one or more of, for example, barometric pressure data, temperature data, humidity data, mobile device motion state data, ambient sound level data, ambient illumination data, mobile device activation and deactivation data, and/or radio frequency (RF) measurement data. Environmental characteristics may then be inferred by aggregating sensor measurement data and/or radio frequency (RF) measurement data received (e.g. crowdsourced) from multiple terminals and applying environmental rules to the aggregated data. In some embodiments, the one or more environmental rules may be first created from common patterns observed for sensor measurements received from locations with known types of environment. The created environmental rules may then subsequently be applied to infer the environments or information related to the environments for locations where there is little, or no, initial environmental information.

The inferred environmental information may assist a wireless operator or other service provider to better provide existing services and/or to provide new services—e.g. by knowing when a served user may be indoors, outdoors, at an airport, in a shopping mall, etc. Such environmental knowledge may assist in positioning of a user, in evaluating and improving network coverage in particular environments and/or in providing other services such a building or map information when a user is known to be inside a building, indications of weather or traffic conditions when a user is known to be outdoors, or information on flight arrivals and departures when a user is known to be at an airport. The gathered environmental information may avoid the need for an operator or other service provider to access and make use of separate map or building information to gather similar information which may be an advantage when map or building information is not available, considered to be confidential, not yet created, out of date or otherwise time consuming or expensive to access and evaluate.

Environmental information can include knowing which locations are indoors or outdoors and knowing the type of environment associated with an indoor or outdoor location (e.g., knowing whether an indoor location corresponds to an airport, shopping mall, home, school, college, office, hospital, library etc.). Outdoor environments may similarly, in some embodiments, be more particularly determined/classified to be a city street, a park, a suburban street, a recreational outdoor area, a rural area, etc. Knowing environmental characteristics corresponding to a location of a mobile device that is not yet accurately known may assist location services by enabling a server (e.g., a location server) to facilitate more exact determination of the location. For example, if an approximate location for a terminal can first be obtained which corresponds wholly or predominantly to a particular type of environment, the terminal or a location server can then employ more accurate positioning that is suited to that particular environment. For example, a location server may use (e.g. instruct the terminal to use) Global Navigation Satellite System (GNSS) or Assisted GNSS (A-GNSS) positioning if the environment is determined to be outdoors, or may use (or instruct the terminal to use) WiFi or Bluetooth® (BT) based positioning for an indoor environment. In addition, sensor measurements (e.g. temperature, sound level, light level, etc.), obtained by a terminal whose location is to be determined, may further facilitate the location determination operations by, for example, including locations corresponding to environments determined to more likely for a terminal and/or excluding locations corresponding to environments determined to be less likely for the terminal.

Furthermore, knowing the environment of a terminal may assist in supporting other services such as navigation and provision of information applicable to a user's current location. For example, if a user is known to be at a location A and needs directions to reach a location B, it could help to know the environment for both locations in order to, for example, instruct the user to leave their current environment and prepare to enter a new one. In another example, if a user is known to be at an airport, an operator could provide information (e.g. webpage links) related to flight schedules, delayed flights, shuttle and taxi services, car rentals, hotels, etc. Environmental data may also be useful in compiling maps or rough schematics for users that, for example, could display street and building information as well indications of different types of buildings. Environmental characteristics can be defined in broad generic terms as well as more particularly. Broad generic environment categories/classifications may include being indoors, outdoors, indoors above ground (e.g. in a tall building), indoors below ground (e.g. in a subway), etc. More precise characterization may include, for example, being in a vehicle (stationary or moving), being in a particular type of building (e.g. airport, office building, house, apartment block, hospital, shopping mall, etc.), being on a street, in an urban square, in a park, on a lake, at a beach, on a train, etc.

With reference to FIG. 1, a schematic diagram of a system 100 configured to implement environmental characteristics determination based on crowdsourced measurement data obtained from one or more devices (e.g., multiple mobile devices) is shown. Determination of environmental characteristics may be performed to, for example, determine characteristics for environments on which little, or no, information is available (e.g., an environment in a remote city or foreign country, an environment where a newly deployed access point is located, an environment of a newly opened street or building or an environment for which public information is lacking such as a commercial office complex or factory). The determined environmental characteristics together with corresponding location information (e.g. latitude, longitude and possibly altitude coordinates) may then be used to generate environment characteristic information (e.g., maps, approximate building plans) for that environment. Such determination of environment characteristics may be useful (e.g. to provide various services like navigation and other location related information) even if the locations of devices in the environments (e.g. including access points and/or mobile devices) are not needed or are already known precisely or approximately by other means. In some embodiments, determination of environment characteristics may be requested by a mobile device in order to, for example, configure its functionality (e.g., adjust transmission power levels, activate and de-activate various transceivers, adjust the level of a ringing tone or change between audible ringing and some other form of user alerting such as vibration or flashing a light, etc.) in accordance with the determined characteristics of the environment.

The system 100 includes a server 110 (e.g., a location server, or any other type of server) configured to communicate, via a network 112 (e.g., a cellular wireless network, a WiFi network, a packet-based private or public network, such as the public Internet), or via wireless transceivers included with the server 110, with multiple network elements and/or mobile devices. For example, as depicted in FIG. 1, the server 110 may be configured to establish communication links with one or more Wireless Local Area Networks (WLAN) nodes (also referred to as access points (APs) or base stations), such as access points 120a, 120b, and 120c, which may be part of network 112, to communicate data and/or control signals to those access points, and receive data and/or control signals from the access points. Each of the access points 120a-c in turn can establish communication links with mobile devices located within range of the respective access points 120a, 120b, and 120c. For example, (i) mobile devices 130a-c are shown to be in communication with the access point 120a, which is depicted in the example system 100 of FIG. 1 to be an access point serving an indoor area 140; (ii) mobile devices 130d-e are shown to be in communication with the access point 120b, which is depicted to be an access point serving an outdoor area; and (iii) mobile devices 130f-g are shown to be in communication with the access point 120c, which is depicted to be an access point serving another indoor area 142. The server 110 may also be configured to establish communication links (directly via a wireless transceiver, or indirectly, via a network connection) with one or more Wireless Wide Area Network (WWAN) base stations or nodes, such as the WWAN access points 150a-c (also referred to as base stations) depicted in FIG. 1, which may be part of the network 112. In some embodiments, any one of the mobile devices 130a-g and/or the server 110 may also be configured to at least receive information from satellite vehicles 160a and/or 160b of a Satellite Positioning System (SPS), which may be used as an independent source of position information. In such embodiments, the server 110 and/or any one of the mobile devices 130a-g may include one or more dedicated SPS receivers specifically designed to receive signals for deriving geo-location information from the SPS satellites. In some embodiments, the server 110 may be part of, attached to, or reachable from network 112, and may communicate with one or more of mobile devices 130a-g via network 112. In such embodiments, the server 110 may communicate via, but not establish communication links with, some or all of WWAN APs 150a-c and WLAN APs 120a-c.

The WLAN access points 120a-c depicted in FIG. 1 may include, for example, WiFi APs, femtocell transceivers, Bluetooth® wireless technology transceivers, cellular base stations, small cell base stations, Home evolved Node Bs (HeNBs), WiMax transceivers, etc. The WLAN access points may be used for wireless voice and/or data communication with any of the illustrated mobile devices, and may also be utilized as independent sources of position data, e.g., through implementation of multilateration-based procedures based, for example, on time of arrival techniques, signal propagation delay techniques and/or signal strength techniques. One or more of the WLAN access points may have locations known to the server 110 which may be configured by an operator for server 110 if the WLAN access points belong to either this operator or a business or other owner with some relationship to the operator (e.g. as a subscribed user of the operator or as a business partner of the operator). The WLAN AP locations may also or instead be known to the server 110 via crowdsourcing of location related data from mobile devices such as mobile devices 130a-g. The known WLAN AP locations may be used by server 110 to assist in obtaining the locations of mobile devices such as mobile devices 130a-g and/or may be provided to mobile devices such as mobile devices 130a-g to assist these mobile devices to determine their own locations when in the vicinity of one or more of the WLAN APs. In some embodiments, the access points 120a-c may be part of, for example, WiFi networks (802.11x), cellular piconets and/or femtocells, Bluetooth® wireless technology networks, an IEEE 802.15x networks, etc. Although three (3) WLAN access points are depicted in FIG. 1, any number of such access points may be used, and, in some embodiments, the system 100 may include no WLAN access points at all, or may include a single WLAN access point. Furthermore, each of the WLAN access points 120a-c may be a moveable node, or may be otherwise capable of being relocated.

The WWAN nodes (or base stations or access points) may also be used for wireless voice and/or data communication, and may also serve as another source of independent information through which mobile devices and/or server 110 may determine the positions/locations of the mobile devices. Similar to WLAN APs 120a-c, the locations of one or more of the WWAN APs 150a-c (e.g. the locations of their antennas) may be configured in server 110 by an operator for server 110 or may be obtained by crowdsourcing and may be similarly used by server 110 to obtain locations for mobile devices 130 and/or may be provided to mobile devices 130 to assist the mobile devices to determine their own locations when in the vicinity of one or more of the WWAN APs.

The WWAN access points 150a-c depicted in FIG. 1 may be part of a wide area wireless network (WWAN) which may be the same as, or different from, the network 112, which may include cellular base stations, and/or other wide area wireless systems. Typically, each of the WWAN access points 150a-c may operate from fixed positions, and provide network coverage over large metropolitan and/or regional areas. A WWAN may be a Code Division Multiple Access (CDMA) network, a Time Division Multiple Access (TDMA) network such as a Global System for Multiple Communications (GSM) network defined by 3GPP, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. A CDMA network may implement one or more radio access technologies (RATs) such as cdma2000 as defined by the 3^{rd} Generation Partnership Project 2 (3GPP2), Wideband-CDMA (WCDMA) as defined by the 3^{rd} Generation Partnership Project 3GPP), and so on. An OFDM network may implement one or more RATs such as Long Term Evolution (LTE) as defined by 3GPP. Although three (3) WWAN access points 150a-c are depicted in FIG. 1, any number of zero or more such access points may be used. Additionally, each of the WWAN access point 150a-c depicted in FIG. 1 may be a moveable node, or may otherwise be capable of being relocated.

The server 110 shown in FIG. 1 may be a location server such as: (i) an enhanced serving mobile location center (E-SMLC) defined by 3GPP; (ii) a secure user plane location (SUPL) location platform (SLP) defined by the Open Mobile Alliance (OMA); (iii) a Home SLP (H-SLP), Discovered SLP (D-SLP) or Emergency SLP (E-SLP) defined by OMA; or (iv) some other location server supporting a proprietary or standard set of location protocols (e.g. as defined by IETF or IEEE). The server 110 may be able to function as more than one type of location server—e.g. may be able to function as both an SLP and E-SMLC.

With continued reference to FIG. 1, to implement environmental characteristic determination based on crowdsourced data, the server 110 may be configured to receive from the multiple mobile devices, at the server 110, measurement data representative of sensor measurements performed by respective at least one sensor of the multiple mobile devices. In some embodiments, the various access points may also be configured to perform sensor measurements (e.g. using sensors housed within them or sensors accessed via a wireless or wireline link) and provide resultant measurement data to the server 110 so as to contribute to the crowdsourcing data collection operations described herein (based on which environmental characteristics can be determined). Furthermore, any of the mobile devices and/or the access points depicted in FIG. 1 may be configured to perform some or all of the environmental characteristics determination operations that the server 110 may be configured to perform (as described further on) using measurement data available to the mobile devices and/or APs from inbuilt or locally accessible sensors.

Mobile devices and/or access points may crowdsource RF measurements to the server 110, including RSSI, RTT and/or S/N measurements for one or more of the mobile devices 130a-g, WLAN APs 120a-c and/or the WWAN APs 150a-c. Receiving crowdsourced measurement data at the server 110 from any mobile device 130 may be performed by receiving the data via a WLAN access point, a WWAN access point, etc., that is in wireless communication with the mobile device 130. The measurement data may be further received by establishing a direct communication link or direct communication session between the server 110 and the mobile device 130 based on one of one or more communication protocols. The direct communication link or communication session may be transported (e.g. transported transparently or non-transparently) through one or more of the WLAN APs 120a-c and/or WWAN APs 150a-c. A direct communication link or session between the server 110 and any of the mobile devices 130a-g may enable the server 110 to request particular types of measurements (e.g. particular sensor measurements and/or particular RF measurements) from a mobile device and specify the conditions under which the measurements should be obtained and/or the conditions under which the obtained measurements should be reported to the server 110. For example, the server 110 may request that measurements be made at fixed periodic intervals (e.g. at 15 minute intervals) and be reported in batches at fixed intervals of 24 hours in order to reduce signaling. The server 110 and any mobile device 130 may employ a protocol such as the Secure User plane Location (SUPL) User plane Location Protocol (ULP), the LTE Positioning Protocol (LPP) and/or the LPP Extensions (LPPe) protocol for any direct communication link or session between server 110 and the mobile device 130 and to control and transfer crowdsourcing measurements. The LPP protocol is defined by 3GPP, and the ULP and LPPe protocols are defined by the Open Mobile Alliance (OMA) all in publicly available documents.

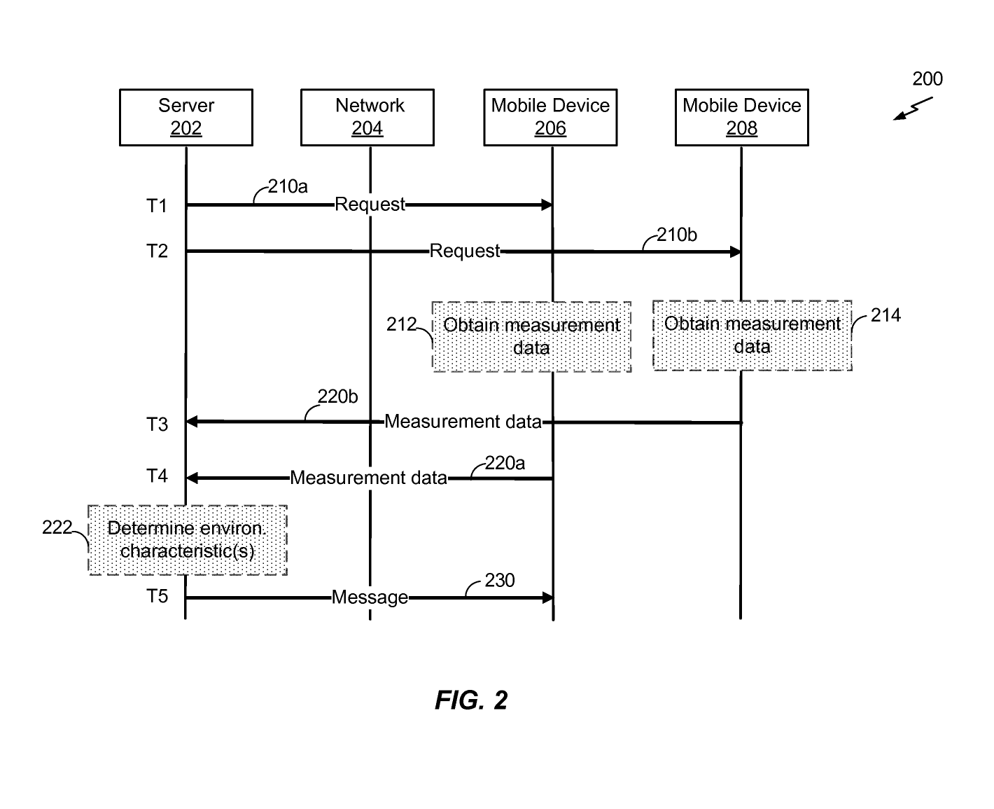

The server 110 may also obtain and control crowdsourcing data provided by any of WLAN APs 120a-c and WWAN APs 150a-c in a similar manner to that described above for obtaining and controlling crowdsourcing measurement data from mobile devices 130. To support a direct communication link or session between server 110 and any of WLAN APs 120a-c or WWAN APs 150a-c, the LPPa protocol defined by 3GPP may be used. For example, the request 210a, the request 210b, the message data 220a and/or the message data 220b described later in association with FIG. 2 may each be an LPPa message or a sequence of LPPa messages.

In some embodiments, receiving measurement data may be performed in response to a request (e.g., periodic request), initiated by the server 110 or by some other network element, to cause the mobile devices 130 to perform measurements using one or more sensors housed by, or coupled to, each mobile device 130, and transmit to the initiating element the measurement data along with any other data pertinent to the procedures described herein, e.g., location of the mobile device 130, time of day, environment identity data, if available. In some embodiments, communication of the measurement data from a mobile device 130 to the server 110 may be initiated by the mobile device 130 (e.g., if the mobile device 130 determines that the mobile device 130 or the user of the mobile device 130 requires data from the server 110 representative of the location or environment for the mobile device 130).

In some embodiments, the server 110 may obtain environmental information from one or more of the mobile devices 130 via positioning of the mobile devices 130 and not necessarily via crowdsourcing. For example, the server 110 may be requested, either directly or indirectly (e.g. via other elements in network 112) by some external client (e.g. a web server, a person, a Public Safety Answering Point (PSAP) or an external client in the mobile device 130 being located), to obtain a location estimate for some target mobile device 130 and to return the location estimate, again directly or indirectly, to the external client. In such a case, the server 110 may instigate a positioning session with the target mobile device 130 using, for example, the OMA SUPL location solution or one of the 3GPP control plane location solutions. As part of the positioning session, the server 110 may request positioning measurements from the target mobile device 130. In an embodiment, the positioning measurements may be requested using the SUPL ULP protocol, the 3GPP LPP protocol, the OMA LPPe protocol or some combination of these. The requested positioning measurements may include certain measurements related to an environment for the target mobile device as described further on herein. The target mobile device 130 may obtain and return some or all of the requested positioning measurements to the server 110. The server 110 may then use the returned positioning measurements to compute a location estimate for the target mobile device 130 and return the location estimate, directly or indirectly, to the requesting external client. The server 110 may also use any sensor based environmental measurements returned by the target mobile device 130 to help infer: (i) characteristics of the environment for the target mobile device 130 as described herein; and/or (ii) environmental rules for determining characteristics for an environment as also described herein when the type of environment for the target mobile device 130 is already known (e.g. from map or building information that is available for the determined location of the target mobile device 130). In these embodiments, a server may be able to determine environmental information over a period of time (e.g. a few months or years) for large areas (e.g. a town, city, state or country) either without the need to make use of crowdsourcing or with less reliance on using crowdsourcing, which may reduce a signaling load on a network and/or reduce the number of mobile devices 130 that need to implement and perform crowdsourcing.

The server 110 is configured to determine environmental characteristics associated with one or more environments at which the mobile devices 130 are located based on one or more environmental rules applied to the measurement data received from the mobile devices 130 (and/or from one or more access points 120 and/or 150). The one or more environmental rules applied at the server 110 are used to determine, or map, measurement data received from mobile devices 130 with likely environmental characteristics that are consistent with the measurement data obtained from the mobile devices 130. Thus, if little, or no information is known about the location and/or environment at which a particular mobile device 130 is currently located (or was previously located in the case of receiving historic measurement data from a mobile device 130 at the server 110), measurements from one or more of the mobile device's sensors may be used, via application of the one or more environmental rules to the received measurement data, to infer the environment at which the mobile device is (or was) located. The one or more environmental rules applied to the measurement data received from the mobile device 130 (and/or to the measurement data received from one or more access points 120 and/or 150 and/or from additional mobile devices 130) may initially be preconfigured to predict a particular environment or environmental characteristic for certain sensor measurements or certain combinations of sensor measurements made at the same time or at a sequence of different times. For example, the environmental rules may be applied to a sequence of measurement data obtained from a mobile device 130 corresponding to data (e.g. sensor) measurements obtained by the mobile device 130 at a sequence of separate time instances and corresponding to a sequence of potentially different locations.

As an example, the server 110 may receive from particular mobile devices, such as the mobile devices 130f and 130g (via the access point 120c), measurement data representative of audio data measured by audio sensors (e.g. microphones) housed by each of the mobile devices 130f and 130g. The server 110 may subsequently apply to the received audio-based measurement data one or more pre-determined environmental rules pertaining to audio data (e.g., environmental rules to infer environmental characteristics from audio data), and determine, based on application of the selected one or more environmental rules to the received data, that for the sound level and ambient sound pattern of the received data, the likely environment at which the mobile devices 130f and 130g are located is an indoor environment or a particular type of indoor environment (e.g. a shopping mall, library, school). This determination may be achieved from a rule that was preconfigured based on offline analysis of audio data sampled at one or more known environments. The determination may also be achieved from a rule that was formulated/created based on previously obtained audio measurement data from, for example, one or more of the mobile devices 130a-c and based on knowledge that the mobile devices 130a-c were located in an indoor environment such as the indoor environment 140 (or in a particular type of indoor environment) at the time that their audio measurement data was obtained. The mobile devices 130a-c (and/or other mobile devices located within the indoor area 140 or inside other indoor areas) may have also provided other measurement data collected while located inside an indoor area, such as: (i) illumination data (e.g. collected via an optical sensor), with such data consistent with light levels that are typical of light levels found in indoor areas (or in a particular type of indoor area) at various times of a day; (ii) RF data representative of RF profiles consistent with what might be detected indoors (e.g., an attenuated signal level from satellite-based transmission and WWAN base stations, and detection of WLAN transmissions); and/or (iii) motion data (e.g. collected via inertial sensors), with such motion data being consistent with motion of users within an indoor area (e.g., slower motion with more frequent stops), etc. Knowing that the mobile devices 130a-c are in an indoor area or in a particular type of indoor area (e.g. a shopping mall, airport, library, museum, office complex, school), server 110 may look for particular individual types of measurement data (e.g. particular illumination levels, particular sound levels, particular RF patterns or particular motion data) and/or particular combinations of two or more types of measurement data (e.g. a particular sound level or range of sound levels combined with a particular type or types of motion data) that are typical for a known environment for mobile devices 130a-c but not typical for all, or at least some, other types of environment.

The following types of sensor related measurements and other data from a mobile device 130 may be used to determine/infer environmental characteristics, and/or establish environmental rules to apply to subsequent sensor related measurement data obtained from one or more mobile devices.
1. Barometric pressure data;
2. Temperature data;
3. Humidity data;
4. Data relating to a motion state for a user of the mobile device (e.g., whether the user is walking, stationary, running, cycling, located in a car, in a train, on a ship, etc.) as may be determined, for example, from inertial sensors such as an accelerometer, a gyroscope, a magnetometer, etc.
5. Ambient sound level data (e.g. volume and frequency range) obtained, for example, from an audio sensor such as a microphone;
6. Ambient illumination data (e.g. illumination level, color range, data related to non-visible illumination such as UV and/or infrared spectrum etc.) obtained, for example, from an optical sensor, such as charge-coupled camera coupled to the mobile device;
7. Mobile device activation/deactivation (e.g. power on/off) time data (e.g., as inferred from gaps in periodic crowdsourcing measurements or a lack of response to paging in the case of power off time, and the presence of periodic crowdsourcing measurements or a response to paging in the case of power on time); and/or
8. RF measurement data (e.g., types and numbers of base stations and APs that are detectable by a mobile device at a particular location and possibly measured signal levels and/or signal to noise ratios for some or all of these base stations and APs).

Other types of measurements data may be obtained in addition to or instead of any of the above identified types of measurement data.

In some embodiments, the server 110 may be configured to determine some or all environmental rules based on previously acquired sensor measurement data representative of sensor measurements performed by one or more sensors of at least one mobile device 130, and based on known environmental characteristics associated with at least one location at which the sensor measurements were performed. For example, environmental rules that map different types of measurement data to a resultant value representative of an indoor environment, or representative of a particular type of indoor environment, may have been formulated, at least in part, by previously obtaining those same types of measurement data from the mobile devices 130a-c at a time when it was known (e.g., from the geographic locations of the mobile devices 130a-c) that those mobile devices were located within the indoor area 140, with the type of the indoor area 140 being also known in the case of a resultant value representative of a particular type of indoor area. Subsequently, the mobile devices 130f-g, located in the indoor environment 142, may provide measurement data to the server 110 (or to some other remote device that can apply the environmental rules formulated based on previously obtained data), with that measurement data sharing attributes that are similar to, or the same as, the attributes of the measurement data provided by the mobile devices 130a-c that was used to formulate, at least in part, the environmental rules. The environmental rules inferred, at least in part, using the measurement data provided by the mobile devices 130a-c may then imply that the mobile devices 130f-g are in an environment 142 similar to or the same as the known indoor environment 140—e.g. may imply that the environment 142 is indoors like environment 140 and/or may further imply that the environment 142 is the same type of indoor environment as environment 140 (e.g. may imply that environment 142 is a shopping mall if environment 140 is a shopping mall). For example, audio data provided by the mobile devices 130f-g may include an ambient audio component that is similar to that found in the audio data previously provided by the mobile devices 130a-c (e.g., the previous and current data may both correspond to sound with a sound level and/or frequency composition indicative of background noise that may be detected in an indoor shopping mall). Accordingly, in this example, an inference may be made, corresponding to a value computed by an environmental rule corresponding to such an inference, that the mobile devices 130f-g are located in an indoor environment. Moreover, in some embodiments, a more particular determination may be made that the mobile devices 130f-g are located in a particular type of indoor environment, such as an indoor shopping mall.

In some instances, some environmental rules may be configured in advance by an operator of a network (e.g. network 112) or a server (e.g. server 110) based on known characteristics of different environments or on characteristics that are obtained via surveys rather than using either crowdsourcing or measurements obtained via positioning of mobile devices. The environmental rules may be similar to environmental rules inferred from measurement data by a server but may have the advantage of being available for use prior to receiving any crowdsourced or positioning related measurements from mobile devices.

Some examples of possible environmental rules that may be configured in a server or inferred by a server based on measurements received from one or more mobile devices in different known environments are listed below. It should be noted that the various numeric values included below could be replaced by other numeric values without necessarily substantially changing the associated environmental rules. It should also be noted that the particular examples below may determine or infer a probability of a particular environment (e.g. a probability greater than 50%) and not a certainty of a particular environment (meaning the inference or determination for any particular environmental rule may sometimes be incorrect).
A. Determine/infer a change of environment when measured temperature or humidity change by at least 5 degrees Celsius (5° C.) or 15%, respectively, over a short period of time (e.g. 2 minutes);
B. Determine/infer an indoor environment when temperature is in the range 16-26° C. and humidity is in the range 10-60%;
C. Determine/infer an outdoor environment for temperature/humidity outside the indoor range;
D. Determine/infer an airport when the motion state data from contributing mobile devices includes data indicating that the user is walking quickly or running and crowdsourcing or paging responses from some mobile devices stop for a long period or begin after some long period during which location significantly changes;
E. Determine/infer a multi-story building when barometric pressure changes by at least 36 Pascals (equivalent to about 3 meters change in altitude) over a period of one minute or less;
F. Determine/infer an indoor environment when three or more WiFi APs, BT APs and/or femtocells are detectable at the same time;
G. Determine/infer an office environment or college campus when the number of mobile devices located in the environment is inferred to be high (e.g. due to receiving crowdsourcing measurements from many mobile devices in the environment) during working hours, but tails off in the evening and is zero or almost zero at night;
H. Determine/infer a multi-story apartment building when the density of mobile devices located in the environment is inferred to be one or more per 1000 square feet (e.g. due to receiving crowdsourcing measurements from this density of mobile devices in the environment) during daylight hours and to rise (e.g. peak) during the evenings and mornings;
I. Determine/infer a house when one or a few mobile devices are located on a partially continuous basis in the environment including outside normal working hours;
J. Determine/infer being on a street in an urban environment when sound level is high during the day and tails off at night; and/or
K. Determine/infer being outside when ambient illumination level is very high in the day time and very low at night.

Many other environmental rules may be similarly defined/formulated. Determination/inference of environmental characteristics based on environmental rules may be implemented, in some embodiments, through a self-learning engine configured to output a determined environmental characteristic(s) (or values representative thereof) in response to measurement input data received from the mobile devices for which environmental characteristics are to be determined.

Inferring new environmental rules from sensor related measurements gathered from many terminals in known environments may enable formulation of reliable and comprehensive environmental rules. For example, a server can look for statistical patterns in sensor measurements and not only determine environmental rules from such patterns but also the probability that each environmental rule will apply (e.g., based on the proportion of sensors measurements, conforming to the environmental rule, that were gathered from a known environment that includes the predicted environmental characteristic). For example, a server (e.g. server 110) could observe different ranges of sound level, light level, user motion state, temperature and humidity that correspond to different environments and create environmental rules corresponding to these ranges. In addition, a server may be configured to also be able to customize some environmental rules according to a particular country, particular geographic location or area, particular time of year, particular day of week and/or particular time of day. As an example, a server may be configured to observe that at a typical shopping mall in the US, the sound level is in a certain high range from 9 am to 9 pm Monday to Saturday and 10 am-6 pm on Sunday corresponding to typical opening hours and in a certain low range outside these times. At a shopping mall in Europe, a server may determine that the high sound level range only applies from 9 am to 6 pm Monday to Saturday, but not on Sunday.

Because more than one environmental rule may be applicable to a collection of sensor measurements received from a terminal or mobile device (e.g. a mobile device 130), it is possible that different conflicting inferences may be produced. To reconcile these, each environmental rule may not only infer a particular environmental characteristic (or set of characteristics) but may also deliver a probability or weight associated with the likelihood that the predicted environmental characteristic or characteristics are correct. In such embodiments, each predicted environmental characteristic may be regarded as a candidate environmental characteristic that may or may not be correct. The probability or weight for each candidate environmental characteristic or characteristics may be used to combine multiple different candidate inferences. Moreover, the probability or weight may depend on how closely the received sensor measurements fit each environmental rule (e.g., the probability associated with a particular environmental rule may be adjusted based on whether or not there is a close fit between the received sensor measurements and the measurement data parameters defining the particular environmental rule). For example, in the case of environmental rule B provided above in the example list of environmental rules, a candidate indoor environment may be inferred with a high probability (i.e., a high weight) if temperature and humidity measurements are near the middles of their respective ranges, and if the mobile device reported a significantly different temperature and/or humidity, outside of the preferred ranges, some time previously or some time later and when at a different location. Multiple candidate inferences with associated weights may be combined through summation or averaging, e.g., by adding the weights or obtaining the average weight for the candidate environmental characteristics and then inferring environmental characteristic(s) with the highest resulting summed or average weight(s) that are compatible with one another. In the case of multiple candidate inferences with associated probabilities rather than associated weights, the probabilities for each candidate characteristic may be multiplied, with the candidate characteristic(s) with the highest resulting product(s) of probabilities, that are compatible with one another, being inferred. In this case, each environmental rule may be adapted to infer probabilities for all environmental characteristics to enable a product of probabilities to be obtained, if needed, for every environmental characteristic. As an example, an environmental rule that assigns a probability of 80% to being indoors would also assign a probability of 20% of being outdoors and might be further adapted to assign probabilities for particular types of indoor and outdoor environments.

The technique described above of combining candidate environmental characteristics to yield a most probable environmental characteristic (or a most probable set of environmental characteristics) may be applied to the sensor measurements provided by just a single mobile device at one location and at one time, or may be applied to a sequence of measurements from a mobile device that were obtained at a sequence of different times and for a sequence of associated locations. Because sensor measurements may depend on the time of day, day of week, the accuracy and reliability of the sensor(s) making the measurements and the disposition of the mobile device at which they were made (e.g. whether the mobile device is in a user's hand, in a pocket, on a belt, in a bag, on a desk, in a cupboard, etc.), inferring reliable environmental characteristics from sensor measurements provided by just a single mobile device may be difficult or may not even be practical. To improve reliability, the environmental rules and techniques of combining candidate environmental characteristics may be applied to sensor measurements provided by a large number of different mobile devices (e.g. hundreds or thousands of mobile devices), which may include measurements provided by these mobile devices at different times. These measurements may be obtained over a period of time (e.g., a week, a month or a year) and may all be for the same location or may be for locations nearby to one another (e.g., locations within 10 to 100 meters of one another).

Because environmental characteristics depend on location, a server (e.g. the server 110) may need to allow for a change of environmental characteristics over small distances (e.g., as exemplified by an indoor environment abruptly changing to an outdoor environment at the exterior of a building). To enable reliable inference of environmental characteristics for different locations, a server may partition a geographic area of interest (e.g., a town, city, state or country) into small areas, referred to here as “partitioned areas,” each comparable to the location accuracy of most mobile devices so as to be able to determine in which partitioned area any mobile device is located when obtaining sensor based measurements. For example, when the horizontal location provided by, or inferred for, a mobile device can typically have an error of 10 meters or less, the partitioned areas might comprise squares of size 20 meters by 20 meters, thus enabling the location of a mobile device to be mapped to one partitioned area in most cases. A server may then aggregate the environmental characteristics predicted by the environmental rules for measurements performed by all mobile devices located within the same partitioned area. A server may need to allow for the possibility that environmental characteristics may change even within the same partitioned area (e.g., in the case of a building whose exterior wall crosses many partitioned areas). A server may therefore infer two or more sets of separate environmental characteristics for some partitioned areas when environmental characteristics inferred from sensor measurements from a significant proportion of mobile devices within the same partitioned area agree with one another, but differ from environmental characteristics inferred from sensor based measurements from other mobile devices in the same partitioned area. Alternatively, in order to simplify inferred environmental characteristics, a server may only infer one environment or one set of self-consistent environmental characteristics for each partitioned area when measurements are provided that imply that a partitioned area may correspond to more than one environment or more than one set of environmental characteristics. The inferred environment or inferred set of environmental characteristics may correspond to that inferred from measurements sent by the greatest number of mobile devices located in the partitioned area. Environments or environmental characteristics that are thus rejected (i.e., not inferred) by the server may still be inferred for other nearby partitioned areas if the environment or environmental characteristics extend over a number of different partitioned areas. The rejected environments or environmental characteristics may therefore still be included in any map derived by the server and may also be used to help locate some mobile devices and provide navigation instructions to other mobile devices.

A server (e.g. the server 110) may also make use of environmental characteristics inferred from sensor based measurements performed by mobile devices (e.g. mobile devices 130) in different but nearby (e.g., adjacent) partitioned areas to increase the reliability of correctly inferring environmental characteristics, based on the likelihood that nearby partitioned areas may be part of a common environment (e.g. such as partitioned areas within the same large building or partitioned areas along a street). Environmental rules may then be configured in or inferred by a server (e.g. the server 110) that indicate the degree of statistical correlation, that may in some cases be positive or negative, between nearby partitioned areas with the same environmental characteristics. For example, a partitioned area corresponding to a shopping mall may be found statistically to have some particular positive correlation with an adjacent partitioned area also corresponding to a shopping mall. A server (e.g. the server 110) may further make use of environmental rules that provide a correlation between different environments or different environmental characteristics occurring in nearby partitioned areas. For example, a partitioned area corresponding to a shopping mall may correlate positively with a nearby partitioned area corresponding to a parking lot or street and may correlate negatively with a nearby partitioned area corresponding to a hospital or sports arena.

In an embodiment, a correlation may be expressed by a correlation coefficient, a conditional probability or by an increase (positive correlation) or decrease (negative correlation) in an unconditional probability. For example, in the case of correlation expressed as a conditional probability, the conditional probability that a partitioned area, adjacent to a partitioned area known to correspond to a shopping mall, will correspond to (i) a shopping mall may be 70%; (ii) a parking lot may be 20%; and (iii) some other environment may be 10%. For example, in the case of correlation expressed as an increase or decrease in an unconditional probability, the probability that a partitioned area, adjacent to a partitioned area known to correspond to a shopping mall, will correspond to (i) a shopping mall may be 50 times the unconditional probability that a partitioned area corresponds to a shopping mall; or (ii) a hospital may be 25% of the unconditional probability that a partitioned area corresponds to a hospital.

Reliance on correlation between environmental characteristics in nearby or adjacent partitioned areas may be useful when sensor based measurements are obtained from too few mobile devices within each partitioned area to yield a statistically reliable inference of environmental characteristics for each partitioned area alone. In that case, several candidate environments or environmental characteristics may be inferred for each partitioned area within a collection of nearby partitioned areas together with an associated probability or weight for each candidate environment or environmental characteristic, and the correlation rules or correlation values (e.g. conditional probability values) may then be applied to determine the most likely set of environmental characteristics or environments with the overall highest probability or weight, such that each partitioned area has just one environment or one set of self-consistent environmental characteristics.

In some embodiments, the size of each partitioned area may be varied depending on the number of mobile devices from which sensor based measurements are obtained within each partitioned area, with the size increased when there would otherwise be a small number of mobile devices (as compared to some pre-determined threshold value of a minimum required number of mobile devices in a given partitioned area) and reduced when there would otherwise be a large number of mobile devices within each partitioned area (e.g., as compared to another pre-determined threshold value of a maximum number of mobile devices in a particular partitioned area). For example, the variation of size may attempt to achieve obtaining sensor based measurements from an equal or similar number of mobile devices in each partitioned area subject to some minimum size (e.g. 10 by 10 meters) and some maximum size (e.g. 1000 by 1000 meters) for each partitioned area. Varying the size of partitioned areas may be useful to (i) reduce data storage size in a server, (ii) allow for more efficient inferences for very large environmental areas such as mountains, forests, farmland and certain other outdoor areas, and/or (iii) enable more precise determination of the boundary and coverage of any particular environment in more populated areas like a city or a town.

In some embodiments, a partitioned area may take any of a number of different shapes including two dimensional (2D) shapes such as a square, rectangle, regular polygon, irregular polygon, circle or ellipse and three dimensional (3D) shapes such as a cube, a rectangular prism, a sphere or an ellipsoid. Although 2D shapes may be more useful and convenient generally, 3D shapes may be useful in capturing and distinguishing different environments within a building or building complex. In some embodiments, an area of interest (e.g. a town, city, state or country) may be partitioned into partitioned areas of (i) an identical type and size (e.g. 20 by 20 meter squares), (ii) an identical type but not identical size (e.g. a square or rectangle of any size) or (iii) a mixture of different types and different sizes. In some embodiments, partitioned areas may overlap one another—e.g. to enable a more precise description of an environment where one set of environmental characteristics slowly change into or overlap with another set, such as where a rural area becomes a suburban area at the edges of a town or where a library is located within a shopping mall. In some embodiments, only part of an area of interest (e.g. a town, city, state or country) may be partitioned into a set of partitioned areas with a remaining area (which may not always be continuous) either not being considered as a partitioned area and having no environmental characteristics determined for it or having some default environmental characteristics (e.g. such as being an outdoor rural area in the case of partitioning of a country or state into partitioned areas located only within or nearby to towns and cities).

In some implementations, environmental rules may be configured to determine when a mobile device may be in a small enclosed space, such as the pocket of a coat or jacket, a bag or drawer of a desk, that results in at least some sensor measurements being heavily biased and not representative of the larger environment in which the mobile device is located. Characteristics of such small enclosed spaces may include a very low level of light, muted sound level and/or a temperature that is higher or lower than the general environment. A server (e.g. the server 110) may be configured to detect a set of mobile devices S1 that are in an enclosed space if a set of other mobile devices, S2, that are not in an enclosed space (e.g. carried in a hand, on a belt, on a wrist) are able to send sensor based measurement data for the same general location at about the same time as the mobile devices in S1. By observing differences between the sensor based measurements reported by the mobile devices in the set S1 and those in the set S2 that are consistent with the mobile devices in the set S1 being in the same general environment as the mobile devices in the set S2 but in a small enclosed space, the server may identify some or all of the mobile devices in the set S1. The server may then either ignore the received sensor based measurements from the mobile devices in the set S1 or may apply modified environmental rules to the sensor based measurements provided by these mobile devices that make predictions of environmental characteristics based on knowing that a mobile device is in a small enclosed space. For example, the modified environmental rules may exclude any environmental rules related to measured illumination, temperature, and other measured environmental data impacted by having the devices in the set S1 located in the enclosed space, since, for example, illumination in a small enclosed space is likely to be low regardless of the external environment, and the temperature may often be different from that for the external environment. The modified environmental rules may also allow for muting of sound level and, for example, may predict a noisy street environment when the sound level exceeds that for a normal indoor environment but is lower than that for a normal street environment.

Thus, in some embodiments, a server (e.g. the server 110) may be configured to compute candidate environmental characteristics and associated weights or probabilities resulting from application of each of the one or more environmental rules to at least a portion of the measurement data received from one or more mobile devices 130 at the same location or at nearby locations (e.g. within the same partitioned area), combine the candidate environmental characteristics based on the weights or probabilities to compute an environmental characteristic based on the combined candidate environmental characteristics. Furthermore, in some embodiments, the weights or probabilities may be computed based on a degree of fit between the measurement data and parameters defining the applied environmental rules. In some embodiments, the process(es) of determining environmental characteristics may further include partitioning an area of interest into a plurality of partitioned areas, obtaining local candidate environmental characteristics for each partitioned area based on measurements performed by mobile devices 130 located in each partitioned area, and determining a probable set of environmental characteristics for the plurality of partitioned areas based on at least one rule providing correlations, which may be positive and/or negative, between environmental characteristics in two or more nearby (e.g. adjacent) partitioned areas in the plurality of partitioned areas. In some embodiments, a respective size of each partitioned area from the plurality of partitioned areas may be adjusted to achieve an equal or similar number of mobile devices 130 providing measurement data representing sensor measurements for each partitioned area.

In order to improve the reliability of the procedures described herein, environments may be assigned to set of categories, possibly, but not necessarily, in the form of a hierarchy. For example, at a top level, environments may be categorized as either being indoor, outdoor, or mixed. An indoor environment may be defined as any environment that is totally or almost totally enclosed (e.g., a concert hall, office building, or hospital). An outdoor environment may be defined as any environment completely lacking in walls, roof, etc., and completely open to the elements (e.g., a city street, park or field). A mixed environment may be defined as any environment that is partially enclosed, e.g., a sports arena with an open field but covered seating, a railway or roadway tunnel, a covered patio, a balcony, etc. For each top level category of environment, a number of lower categories of environment may be defined that are more specific. For example, in the case of an outdoor environment, the lower categories could correspond to urban, suburban and rural environments. In the case of indoor environments, the lower categories could correspond to large buildings, small buildings, large covered spaces (e.g., a concert hall or theatre) and subways. In the case of a mixed environment, the lower categories could correspond to “walled with no roof” environments (e.g., a courtyard of a building) and “roofed but not completely walled” environments (e.g., a tunnel). Further categories may be defined based on other common characteristics, e.g., buildings in which noise level is typically very low (such as a library, art gallery, or museum) may constitute a category. More specific environments (e.g., a school, office building, apartment building, town square, forest, etc.) may then each be assigned to one or more categories. Categories themselves may also be associated with other categories. For example, a “very quiet building” category could be a member of both a “large building” category and a “small building” category.

Categorizing environments may make inferring environmental characteristics from received (e.g. crowdsourced) measurements more reliable and accurate. For example, assume that sensor based measurements received from mobile devices located in different specific environments that all belong to the same environmental category “CA” are typically similar to one another but are typically dissimilar to sensor based measurements received from mobile devices located in other environments associated with environmental categories different from CA. In this case, it may be possible to infer environmental category CA for a particular location or set of nearby locations with high reliability from measurements received from a limited number of mobile devices that are at this particular location or at this set of nearby locations. Knowing an environmental category for a particular location or set of nearby locations may be valuable to a server (e.g. server 110), e.g., to assist precise location of mobile devices that are at this particular location or at this set of nearby locations or to provide navigation or other location related data to these mobile devices. Further, once an environmental category is known, a server may find it easier to discover the specific environment by applying environmental rules to later sensor measurements provided by mobile devices that only discriminate between specific environments belonging to the inferred environmental category rather than discriminating between all possible specific environments. Similarly, a server may infer environmental rules related to environmental categories, which may be referred to as “environmental category rules”, by observing common patterns in received sensor based measurements from mobile devices in a known category of environment. A server may also look out for similar sensor based measurements received (e.g. crowdsourced) from mobile devices located in different specific environments in order to create new categories of environment and new environmental category rules that associate received (e.g. crowdsourced) measurements to each new category of environment. As an example, environmental rules A, B, C, E, F, K (as provided above) relate to categories of environment (and may thus be considered to be environmental category rules), whereas environmental rules D, G, H, I, J relate to specific types of environment. A server (e.g. the server 110) that makes use of environmental categories may first apply environmental category rules (i.e. environmental rules related to categories of environment such as A, B, C, E, F, K above) when receiving sensor-based (e.g. crowdsourced) measurements from mobile devices at or nearby to the same location in order to derive one or more environmental categories for this location. The server may then, or later, apply environmental rules related to specific environments (e.g., environmental rules such as D, G, H, I, J provided above) to determine a specific environment for the location. In determining a specific environment for the location, a server may only apply environmental rules that are consistent with specific environments that belong to whatever categories of environment were previously determined for the location to improve efficiency and avoid erroneous inference. For example, if an environmental category was determined to be a “large building” for some location (e.g., by application of environmental category rules such as A, B, C, E, F, K above), then environmental rules D, G and H above may be applied subsequently to help determine the exact type of large building (e.g. whether it is an airport, office building, apartment complex, or college campus) but not environmental rules I and J which are not associated with a large building.

Thus, in some embodiments, one or more categories of environmental characteristics may be determined for one or more locations visited by multiple mobile devices, based at least in part on one or more environmental category rules (which may be selected from a general set of environmental rules that includes all the available environmental rules that may be used to determine environmental characteristics) applied to the measurement data received from the multiple mobile devices. One or more specific environments or specific environmental characteristics may also be determined based at least in part on the determined categories of environmental characteristics.

As noted, in some embodiments, the environmental characteristics determination rules/processes (e.g., to determine one or more environmental characteristics based on current and/or historic measurement data obtained from mobile devices) may include machine learning implementations in which determination of environmental characteristics based on measurement data from multiple mobile devices can be dynamically learned over time. Thus, a server 110 (or some other system/machine in communication therewith) may include a dynamically configurable learning/analysis module operable to determine environmental characteristic(s) for particular locations as a function of measurement data received from mobile devices that was previously collected by the mobile devices' respective one or more sensors when at these locations. In some implementations, such a machine learning module may be configured to iteratively analyze training input data (e.g., a set of provided measurement data collected by multiple mobile devices located in known locations and/or in known environments) and to associate this measurement data with the known environments and/or with known environmental characteristics for the known locations, thereby enabling later determination of the same environments and/or same environmental characteristics when presented with similar input data from other mobile devices at the same or other locations at a later time. Using the training data, such a machine learning implementation may be configured to derive functions, models, environmental rules, environmental category rules, processes, etc., that cause subsequent inputs of, for example, measurement data from one or more mobile devices, to produce outputs (e.g., values representative of candidate environmental characteristic(s) and their associated weights or probabilities) that are consistent with the learning machine's learned behavior.

In some embodiments, the learning machine implementation may be realized using a neural network system. A neural network may include interconnected processing elements (effectively the systems' neurons). The connections between processing elements in the neural network may have weights that cause output from one processing element to be weighted before being provided as input to the next interconnected processing elements. The weight values between connections may be varied, thereby enabling the neural network to adapt (or learn) in response to training data it receives. In some embodiments, the learning machine may be implemented using support vector machines, decision trees techniques, regression techniques to derive best-fit curves, and/or other types of machine learning procedures/techniques.

In some embodiments, determination of environmental characteristic(s) associated with one or more mobile devices (e.g. mobile devices 130) that provide measurement data to a server (e.g. server 110) may be used to facilitate location determination for one or more of the mobile devices or may be used to facilitate navigation operations or provision of other location related content or assistance to one or more of the mobile devices. In the case of location determination, the server, some other remote network device, or one or more of the mobile devices themselves may perform the operation(s) to determine the location of one or more of the mobile devices. For example, the server may send a positioning protocol message or other signal to a mobile device determined (e.g. based on sensor measurement data it, and possibly other mobile devices, provided to the server) to be in an outdoor environment to cause the mobile device to activate its GNSS positioning functionality, or may send a positioning protocol message or other signal to that mobile device to cause the mobile device to activate its WiFi functionality and/or Bluetooth® wireless technology functionality (or other near-field communication functionality) when the mobile device is determined to be indoors. In some embodiments, the server 110 may be configured to send to at least one mobile device navigation data or other location content determined based on the environmental characteristics determined from the measurement data provided by the mobile device. Such navigation data or other location content may include one or more of, for example, map data associated with an environment where the at least one mobile device is located, navigation instructions to facilitate navigation of the at least one mobile device, and/or information pertinent to the environmental characteristics such as weather information (e.g. a storm warning) for an outdoor environment or taxi, shuttle and hotel information for an indoor environment determined to be an airport. In some embodiments, the determined environmental characteristics may be stored at the server (or at some other remote device) and/or may be used to construct environmental characteristic maps representative of the characteristics of the environments from which the received (e.g. crowdsourced) data was collected.

In some embodiments, and for example if the user of a mobile device has given advance permission, the inferred environmental characteristics for a mobile device may be tracked (e.g. whenever the mobile device provides sensor measurements to the server when being positioned by the server) with services then being rendered to the user of the mobile device (e.g. by the server or by another entity) when certain changes in environmental characteristics for the mobile device are inferred. For example, if the specific environment for a mobile device is inferred to change from being outdoors on a city street to being inside a railway station, the server (or another entity) may provide information on delayed or cancelled trains if the particular railway station can be identified from the mobile device location (or approximate location) and the server (or other entity) has access to this information.

FIG. 2 is a signal flow diagram 200 illustrating at least part of the interactions between some of the various elements depicted in FIG. 1, and the processes that may be implemented by those various elements. In some embodiments, at a time instance T1 a server 202 (which may be a location server and/or may be similar to or the same as the server 110 of FIG. 1), transmits a request 210a to obtain measurement data to a mobile device 206 located in an environment about which little, or no, information is available. At time instant T2, the server 202 transmits another request 210b to obtain measurement data to another mobile device 208. The requests 210a and 210b may occur substantially simultaneously or at different times. Server 202 may transmit additional requests similar to or the same as 210a and 210b to other mobile devices not shown in FIG. 2 to obtain measurement data from these other mobile devices. Each of the requests 210a and 210b may be transferred to the recipient mobile devices via a network 204 which may be similar to or the same as network 112 in FIG. 1. The requests may thus be forwarded to the target mobile devices via access points, such as any of the access points 120a-c and/or 150a-c depicted in FIG. 1. The mobile devices 206 and 208 may be similar to or the same as any two of the mobile devices 130a-g in FIG. 1. In some embodiments, each of the requests 210a and 210b may comprise an LPP Request Location Information message containing an embedded LPPe Request Location Information message. In some embodiments, the requests 210a and 210b may comprise requests for crowdsourcing data. In some other embodiments, the requests 210a and 210b may comprise requests for positioning data to enable server 202 to determine a location for each of mobile devices 206 and 208 and/or environmental data for these mobile devices. Each request may indicate certain sensor based measurements that the recipient mobile device is requested to measure, trigger conditions (e.g., a start time, periodic interval and end time) for determining when the measurements are to be performed and trigger conditions for reporting measurement data back to location server 202 (e.g., such as a periodic reporting interval). In some embodiments, the trigger conditions may be included for requests that are for crowdsourced data but not for requests that are for positioning data. The environment for each mobile device may correspond to an environment for which the server 202 has little or no data, an environment for which the server 202 has some data that needs to be verified or updated, or to an environment for which the server has valid data. As noted, any number of mobile devices may be contacted and requested to obtain and provide measurement data.

In response to receiving the requests 210a and 210b, the mobile devices 206 and 208 perform measurements (at 212 and 214) either immediately (e.g. in the case of requests for positioning data) or (e.g. in the case of requests for crowdsourcing data) at one or more later times and at one or more different locations. The measurements may be performed by the mobile devices 206 and 208 using various on-board sensors, including, such sensors as motion/inertial sensors (e.g. accelerometers, gyroscopes, magnetometers), transceivers to receive RF signals from nearby APs and base stations, audio sensors, optical sensor, pressure sensors, temperature sensors, humidity sensors, etc. Each mobile device, 206 and 208 and other mobile devices not shown in FIG. 2 may then each assemble a message or messages (220a and 220b in the case of mobile devices 206 and 208) containing measurement data representative of the measurements made previously (at 212 and 214 in the case of mobile devices 206 and 208) and transmit the message or messages to the server 202, at times T3 and T4 in the case of mobile devices 208 and 206, respectively. In some embodiments, the message or messages transmitted by a mobile device may include a location estimate, or RF measurements (e.g. GNSS measurements and/or measurements for nearby base stations and APs such as signal timing, signal strength and/or signal to noise ratio) from which a location estimate can be derived by server 202, for one or more of the locations at which sensor measurements were performed by the mobile device. In some embodiments, the messages 220a and 220b may each comprise an LPP Provide Location Information message containing an embedded LPPe Provide Location Information message. Subsequent to times T3 and T4 (e.g. in the case that requests 201a and 201b are requests for crowdsourcing measurements), mobile devices 206 and 208 and possibly other mobile devices may perform further sensor based measurements (e.g. at one or more later times) and transmit additional measurement data related to these further measurements to server 202.

In some embodiments (e.g. when the requests 210a and 210b are requests for crowdsourcing measurements), one or more of the mobile devices 206 and 208 may perform sensor measurements at one or more different times related to environments in which the mobile devices are currently located, and may store the sensor measurements along with other pertinent information. The other pertinent information may comprise: (i) the current location of each mobile device (e.g. a geographic location that may comprise a latitude, longitude and possibly altitude); (ii) measurements of SPS satellites such as satellites 160 and/or of APs such as WWAN APs 150 and/or WLAN APs 120 which may enable server 202 to determine a location for a mobile device; and/or (iii) the current date and time. At some later times T3 and T4 (e.g. which may occur an hour, a day or a week after the times T1 and T2 at which the requests 210a and 210b were sent), the stored sensor measurements and other pertinent information may be sent to the server 202 in the messages 220a and 220b by the mobile devices 206 and 208. The one or more of the mobile devices 206 and 208 may continue to obtain and store sensor measurements and other pertinent information and to send the stored information to the server 202 in repetitions of messages 220a and 220b at later times—e.g. according to control information received in the requests 210a and 210b which may indicate when sensor measurements and other pertinent information are to be obtained by the mobile devices 206 and 208 and when this information is to be sent to the server 202. In these embodiments, server 202 may use the received measurement information to infer environmental characteristics for locations at which mobile devices 206 and 208 were located at some previous set of times which may be useful to create a map or database of known environmental characteristics for different locations (e.g. locations corresponding to a set of partitioned locations for a particular town or city). The received measurement information may also be used to infer new environmental rules or to validate or update existing environmental rules using measurement information received from mobile devices 206 and 208 when at locations whose environmental characteristics are already known. The fact that the measurement information may be received by server 202 in messages 220a and 220b some time (e.g. an hour, a day or a week) after the measurement information was collected by mobile devices 206 and 208 may not impede or degrade these server functions and may enable more efficient use of network 204 signaling resources and more efficient server processing by reducing the number of separate messages 220a and 220b that are sent by the mobile devices 206 and 208 and processed by the server 202.

Based on the measurement data received by the server 202 from the mobile devices 206 and 208, and possibly from other mobile devices not shown in FIG. 2, the server 202 determines (at 222) one or more environmental characteristics representative of the environments associated with the locations of mobile devices 206 and 208 and possibly with other mobile devices. As described herein, determination of the environmental characteristics at which the mobile devices are located may be based on one or more environmental rules (e.g., preconfigured environmental rules, or environmental rules inferred from previous measurements for known locations and/or known environments using a learning engine) that are applied to the measurement data as described previously. As also noted, because the application of the one or more environmental rules to the received measurement data may yield inconsistent results (e.g., inconsistent environmental characteristics), in some embodiments, the computed results (e.g. corresponding to candidate environmental characteristics) are combined according to weights or probabilities associated with the computed results to compute a resultant environmental characteristic. If the server 202 already has valid environmental data for the locations of mobile devices 206 and 208, then the server may use the known environmental data and the measurement data to infer, verify or update environmental rules associating the measurement data received in messages 220a and 220b to the known environmental characteristics at 222. The inferred, verified or updated environmental rules may be stored and used later, e.g., when signal flow 200 is repeated later for other mobile devices.

The determined environmental characteristics may be stored at the server (or at some other remote device) and/or may be used to construct environmental characteristic maps representative of the characteristics of the environments at which the mobile devices 206 and 208 (and other mobile devices) are located. In some embodiments, at least some of the environmental characteristic(s) determined for the mobile devices 206 and 208 (or some other data derived from or using these environmental characteristics) may be transmitted (at some later time T5) in a message 230 to the mobile devices 206 and/or 208 or to some other mobile device not shown in FIG. 2. While FIG. 2 shows only the message 230 being transmitted to the mobile device 206 at the time T5, separate messages may be sent to any number of mobile devices. In some embodiments, the message 230 may include, in addition to or instead of some of the environmental characteristics (or the derived environmental data), navigation data that may assist the user of mobile device 206 to move to a desired location. Alternatively, if one of the environmental characteristics determined for the environment in which the mobile device 206 is located was that of an indoor environment, the message 230 may include instructions to cause the mobile device 206 to activate its WLAN transceivers, and de-activate its GNSS transceiver. A more particular instruction provided in the message 230 sent to the mobile device 206 may be to activate a WiFi transceiver if the determination was that the mobile device is located in an indoor environment. As another example, the message 230 may include environment related content such as a store plan for an indoor shopping mall, weather or traffic information for an outdoor street environment or travel information for an environment corresponding to a railway station or airport.

As noted, in some embodiments, determination of environmental characteristics for one or more mobile devices 130 may be initiated by the mobile device, e.g., in circumstances where the one or more initiating mobile devices need to determine the characteristics associated with the environments in which they are located. In such embodiments, the initiating messages may be messages such as the measurement data messages 220a and 220b, and may be sent by the mobile devices 206 and 208 in some embodiments without receiving the requests 210a and 210b. Further, in some embodiments, the messages 220a and 220b, and/or other messages sent by mobiles devices 206 and 208 (not shown in FIG. 2) that are associated with messages 220a and 220b, may request that the receiving server (in this example, the server 202) process the measurement data messages (e.g. messages 220a and 220b) so as to apply one or more environmental rules in order to determine environmental characteristic(s) associated with the environment(s) of the initiating mobile devices 206 and 208. The messages 220a and 220b, and/or the other messages sent by mobiles devices 206 and 208 associated with messages 220a and 220b, may further request that the receiving server (server 202) provide some service related to the determined environmental characteristics, such as providing navigation directions, map data, weather information (e.g. for an outdoor environment), travel information (e.g. for an airport or railway station). The particular services provided may be indicated in the messages 220a and 220b (or the other messages sent to request the services) or, since the mobile devices 206 and 208 may not know the environmental characteristics when sending the requests, may be known to the server 202 or the provider of server 202 as being of potential usefulness to mobile devices 206 and 208 or to the users of these mobile devices.

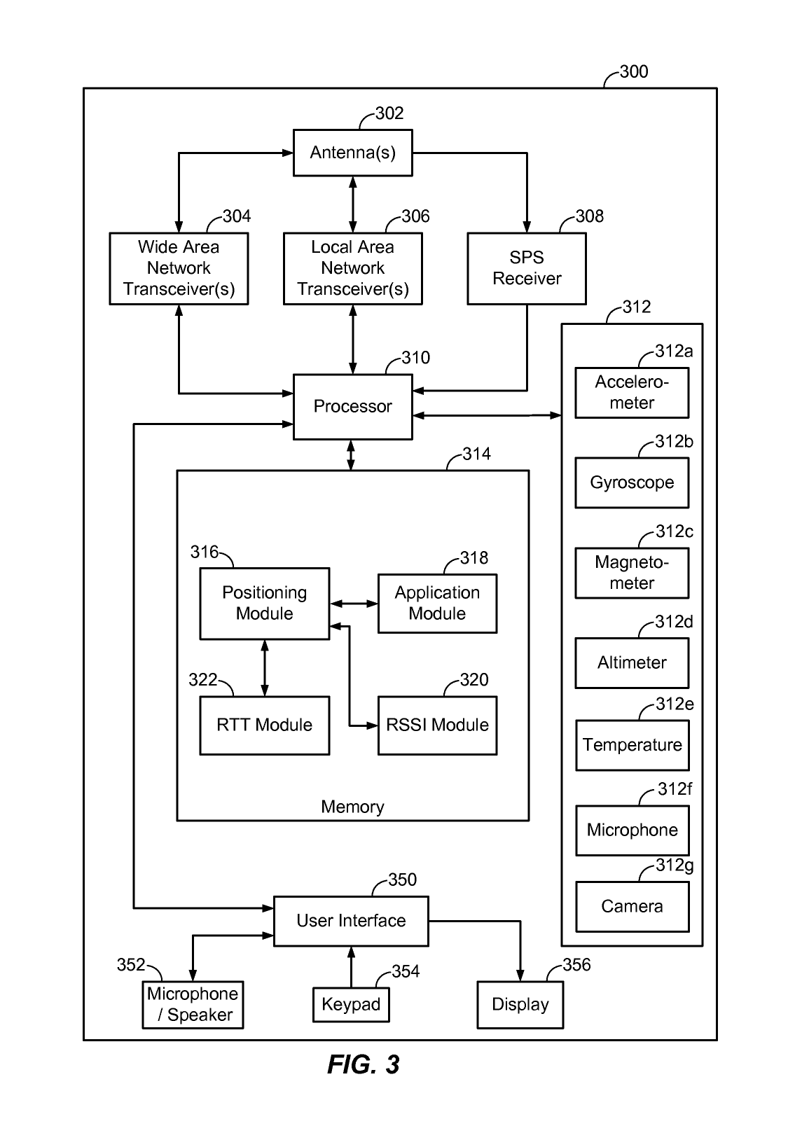

With reference now to FIG. 3, a schematic diagram illustrating various components of an example mobile device 300 is shown, which may be similar to or the same as any of the mobile devices 130a-g depicted in FIG. 1, any of the mobile devices 206 and 208 depicted in FIG. 2 and any unlabeled mobile device referred to previously in the description of the different techniques and procedures disclosed herein. For the sake of simplicity, the various features/components/functions illustrated in the schematic boxes of FIG. 3 are connected together mainly through a processor/controller 310. However, it will be appreciated that other methods of connecting together features/components/functions could be used instead or in addition such connection using a common bus. Furthermore, one or more of the features or functions illustrated in the example of FIG. 3 may be further subdivided, or two or more of the features or functions illustrated in FIG. 3 may be combined. Additionally, one or more of the features or functions illustrated in FIG. 3 may be excluded. In some embodiments, some or all of the components depicted in FIG. 3 may also be used in implementations of one or more of the access points 120a-c and/or 150a-c illustrated in FIG. 1. In such embodiments, the components depicted in FIG. 3 may be configured to cause the operations performed by access points as described herein (e.g., to receive and forward communications to and from the server 110 and any of the mobile devices 130a-g of FIG. 1, to obtain measurement data from locally housed sensors, and/or to perform at least some of the functions of the procedures and methods described herein).

As shown, the mobile device 300 may include one or more local area network transceivers 306 that may be connected to one or more antennas 302. The one or more local area network (LAN) transceivers 306 comprise suitable devices, hardware, and/or software for communicating with and/or detecting signals to/from one or more of the WLAN access points 120a-c depicted in FIG. 1, and/or directly with other wireless devices within a network. In some embodiments, the local area network transceiver(s) 306 may comprise a WiFi (802.11x) communication transceiver suitable for communicating with one or more wireless access points; however, in some embodiments, the local area network transceiver(s) 306 may be configured to communicate with other types of local area networks, personal area networks (e.g., Bluetooth® wireless technology networks), etc. Additionally, any other type of wireless networking technologies may be used, for example, Ultra Wide Band, ZigBee, wireless USB, etc.

The mobile device 300 may also include, in some implementations, one or more wide area network (WAN) transceiver(s) 304 that may be connected to the one or more antennas 302. The wide area network transceiver(s) 304 may comprise suitable devices, hardware, and/or software for communicating with and/or detecting signals from one or more of, for example, the WWAN access points 150a-c illustrated in FIG. 1, and/or directly with other wireless devices within a network. In some implementations, the wide area network transceiver(s) 304 may comprise a CDMA communication system suitable for communicating with a CDMA network of wireless base stations. In some implementations, the wireless communication system may comprise other types of cellular telephony networks, such as, for example, TDMA, GSM, WCDMA, LTE etc. Additionally, any other type of wireless networking technologies may be used, including, for example, WiMax (IEEE 802.16), etc.

In some embodiments, an SPS receiver (also referred to as a global navigation satellite system (GNSS) receiver) 308 may also be included with the mobile device 300. The SPS receiver 308 may be connected to the one or more antennas 302 for receiving satellite signals. The SPS receiver 308 may comprise any suitable hardware and/or software for receiving and processing SPS signals. The SPS receiver 308 may measure SPS signals from one or more SPS satellite vehicles (e.g. may measure pseudoranges for these signals), may request information as appropriate from other systems or entities (e.g. may request, or may cause a request from mobile device 300 for, A-GNSS assistance data from a server such as server 110 to assist with acquisition and measurement of SPS signals and/or assist with location computation using SPS signal measurements), and may perform the computations necessary to determine the position of the mobile device 300 using, in part, any measurements obtained by SPS receiver 308.

As further illustrated in FIG. 3, the example mobile device 300 includes one or more sensors 312 coupled to the processor/controller 310. For example, the sensors 312 may include motion sensors to provide relative movement and/or orientation information (which may be independent of motion data derived from signals received by the wide area network transceiver(s) 304, the local area network transceiver(s) 306 and/or the SPS receiver 308). By way of example but not limitation, the motion sensors may include an accelerometer 312a, a gyroscope 312b, and a geomagnetic (magnetometer) sensor 312c (e.g., a compass), any of which may be implemented based on micro-electro-mechanical-system (MEMS), or based on some other technology. The sensors 312 may further include an altimeter (e.g., a barometric pressure altimeter) 312d, a thermometer (e.g., a thermistor) 312e, an audio sensor 312f (e.g., a microphone), a light sensor or image sensor 312g (e.g. a digital camera) and/or other sensors. The output of the sensors 312 may be provided as part of the measurement data transmitted to a remote device or server such as the server 110 or the server 202 (e.g. may be provided via the transceivers 304 and/or 306, or via some network port or interface of the device 300), to enable environmental characteristics associated with the environment at which the mobile device 300 is located to be determined by the remote device or server. In some embodiments, the one or more sensors 312 may include a camera 312g (e.g., a charge-couple device (CCD)-type camera), which may produce still or moving images (e.g., a video sequence) that may be displayed on a user interface device, such as a display or a screen, and that may be further used to determine an ambient level of illumination and/or information related to colors and existence and levels of UV and/or infra-red illumination.

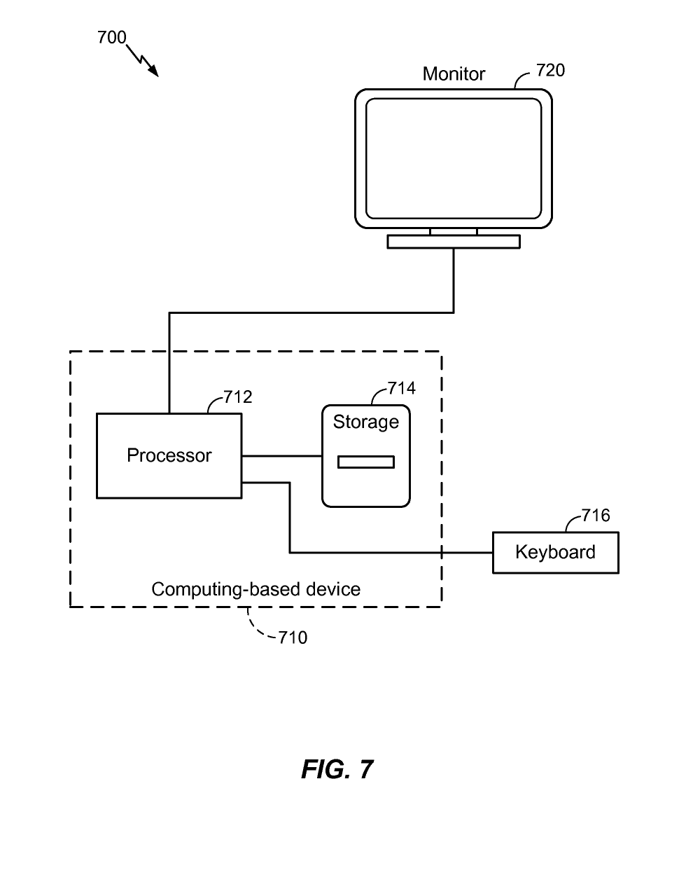

The processor(s) (also referred to as a controller) 310 may be connected to the local area network transceiver(s) 306, the wide area network transceiver(s) 304, the SPS receiver 308 and the one or more sensors 312. The processor 310 may include one or more microprocessors, microcontrollers, and/or digital signal processors that provide processing functions, as well as other calculation and control functionality. The processor 310 may be coupled to storage media (e.g., memory) 314 for storing data and software instructions for executing programmed functionality within the mobile device. The memory 314 may be on-board the processor 310 (e.g., within the same IC package), and/or the memory may be external memory to the processor and functionally coupled over a data bus. Further details regarding an example embodiment of a processor or computation system, which may be similar to the processor 310, are provided below in relation to FIG. 7.

A number of software modules and data tables may reside in memory 314 and be utilized by the processor 310 in order to manage both communications with remote devices/nodes (such as the various access points 120 and 150 and/or the server 110 depicted in FIG. 1), perform positioning determination functionality, and/or perform device control functionality. As illustrated in FIG. 3, in some embodiments, memory 314 may include a positioning module 316, an application module 318, a received signal strength indicator (RSSI) module 320, and/or a round trip time (RTT) module 322. It is to be noted that the functionality of the modules and/or data structures may be combined, separated, and/or be structured in different ways depending upon the implementation of the mobile device 300. For example, the RSSI module 320 and/or the RTT module 322 may each be realized, at least partially, as a hardware-based implementation, and may thus include such devices as a dedicated antenna (e.g., a dedicated RTT and/or RSSI antenna), a dedicated processing unit to process and analyze signals received and/or transmitted via the antenna(s) (e.g., to determine signal strength of a received signals, determine timing information in relation to an RTT cycle), etc.

The application module 318 may be a process running on the processor 310 of the mobile device 300, which requests position information from the positioning module 316. Applications typically run within an upper layer of the software architectures, and may include indoor navigation applications, shopping applications, location aware service applications, etc. The positioning module 316 may derive the position of the mobile device 300 using information derived from various receivers and modules of the mobile device 300, e.g., based on measurements performed by the RSSI module 320, the RTT module 322, the WAN transceivers 304, the LAN transceivers 306, and/or the SPS receiver 308. The positioning and application modules 316 and 318 may also perform various processes (e.g., determine location estimates, perform navigation operations) based, in part, on environmental characteristics, determined based on measurement data provided in part by the mobile device, received from a remote server (such as the server 110 of FIG. 1) or from an access point the mobile device 300 communicates with.

The mobile device 300 may further include a user interface 350 which provides any suitable interface systems, such as a microphone/speaker 352, keypad 354, and a display 356 that allows user interaction with the mobile device 300. The microphone/speaker 352 (which may be the same as or different from the sensor 312f) provides for voice communication services (e.g., using the wide area network transceiver(s) 304 and/or the local area network transceiver(s) 306). The keypad 354 comprises any suitable buttons for user input. The display 356 comprises any suitable display, such as, for example, a backlit LCD display, and may further include a touch screen display for additional user input modes.

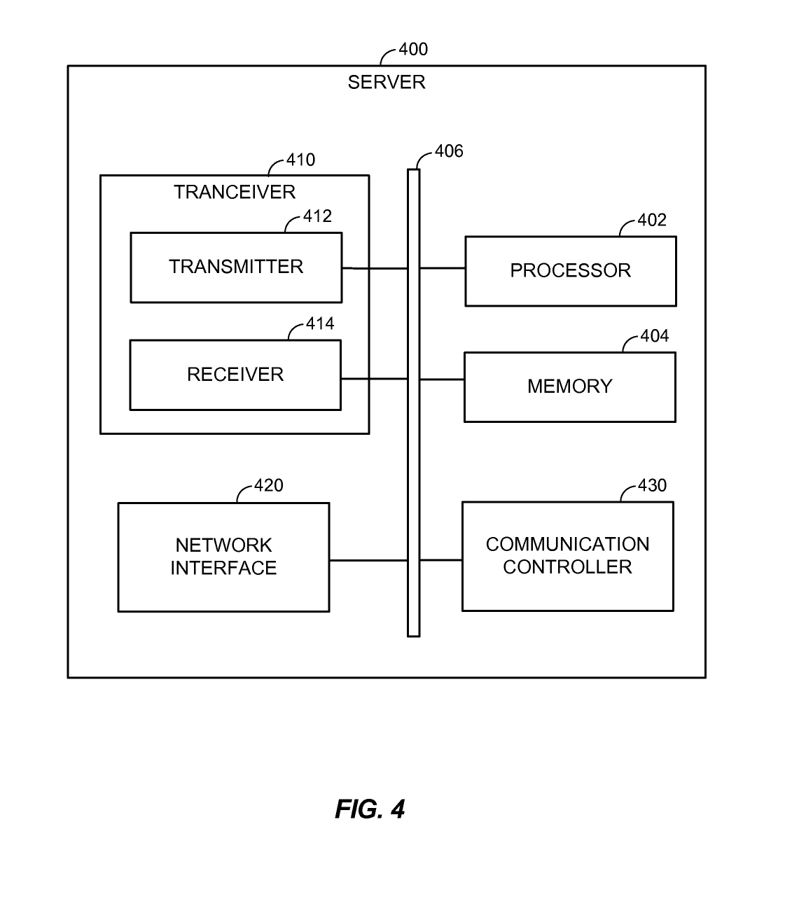

With reference now to FIG. 4, a schematic diagram of an example server 400 is shown, which may be similar to, and/or be configured to have a functionality similar to or the same as that of, the server 110 depicted in FIG. 1 and/or the server 202 depicted in FIG. 2. The server 400 may include a transceiver 410 for communicating with wireless nodes, such as, for example, the networks 112 and 204 and the devices 120a-c, 130a-g, 150a-c, and/or 300 shown in FIGS. 1-3. The transceiver 410 may include a transmitter 412 for sending signals (e.g., downlink messages such as messages 210a, 210b, and 230 in FIG. 2) and a receiver 414 for receiving signals (e.g., uplink messages such as messages 220a and 220b in FIG. 2). The server 400 may include a network interface 420 to communicate with other network nodes (e.g., sending and receiving queries and responses). For example, each network element may be configured to communicate (e.g., using wired or wireless communication) with a gateway, or other suitable entity of a network, to facilitate communication with one or more core network nodes or to support communication with an external client (e.g. to enable provision of location services to an external client). Additionally and/or alternatively, communication with other network nodes and other entities may also be performed using the transceiver 410.

The server 400 may also include a controller 430 to manage communications with other nodes (e.g., sending and receiving messages) and to provide other types of functionality. The server may further include a processor or set of processors 402 (one or more of which may be used to implement the controller 430) and a memory 404. For example, when implemented in a manner similar to that of the server 110 of FIG. 1, the processor 402 may be configured, based on instructions and data stored in memory 404, to determine environmental characteristics associated with one or more environments visited by multiple wireless devices (which provided measurement data representative of sensor measurements performed by sensors of the multiple mobile devices) based on output resulting from application of one or more environmental rules applied to the measurement data. Such resultant environmental characteristics may then be stored in the memory 404 at the server 400 (e.g., to form an environmental characteristics map for the various environments at which the mobile devices are or were located), transmitted to other wireless devices (e.g., to the mobile devices that provided the measurement data), and/or further processed by the server 400. The processor 402 may be further configured (e.g., according to instructions stored in memory 404) to observe common patterns in sensor based measurements provided by multiple mobile stations and to infer environmental rules associating sensor-based measurements with known environmental characteristics (e.g. also stored in memory 404) for known locations or known environments of the mobile devices. The inferred environmental rules may be stored in memory 404 and used later by processor 402 to infer environmental characteristics for mobile devices in unknown environments that provide sensor-based measurement data. The elements 402, 404, 410, 412, 414, 420, 430 for server 400 may be enabled to communicate with another via a common bus 406, e.g., in order to transfer data and instructions from memory 404 to processor 402 and to transfer inferred environmental characteristics and inferred environmental rules from the processor 402 to the memory 404.

The memory 404 may include a storage device that includes random access memory (RAM), read-only memory (ROM) and/or secondary storage such as magnetic disk memory, magnetic tape memory and/or solid state disk memory. The memory 404 may be configured to store processor-readable, processor-executable software code containing instructions that when executed on the controller 430 and/or the processor(s) 402 cause the functions and operations described herein to be performed. Software may be loaded onto the memory 404 by, for example, being downloaded via a network connection, uploaded from a disk, etc. Furthermore, the software may not be directly executable, e.g., it may require compiling before execution. The instructions stored in the memory 404 are configured to enable the controller 430 and/or the processor(s) 402 to perform various actions, including implementing the various environmental characteristics determination/inference procedures described herein.

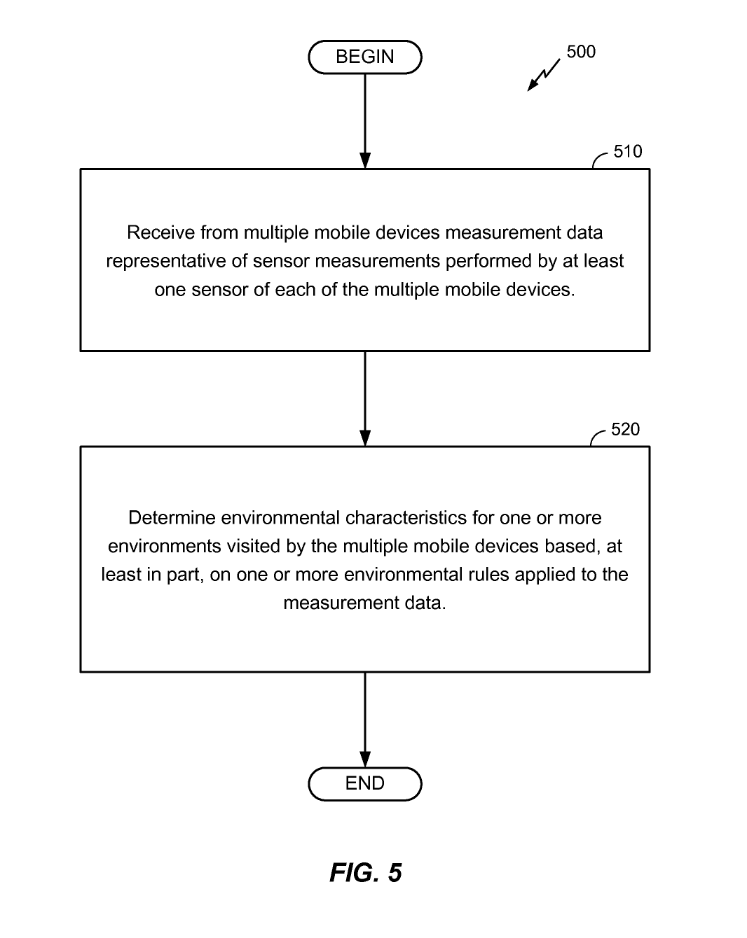

With reference to FIG. 5, a flowchart of an example procedure 500, generally performed at a remote processor-based device (such as the server 110 of FIG. 1, the server 202 of FIG. 2, the server 400 of FIG. 4 or at any other processor-based device, including a mobile device), for environmental characteristics determination is shown. The procedure 500 includes receiving 510 from multiple mobile devices, at a processor-based device server (such as the server 110 of FIG. 1 or server 202 of FIG. 2), measurement data representative of sensor measurements performed by at least one sensor of each of the multiple mobile devices. In some embodiments, the measurement data may include one or more of, for example, barometric pressure data, temperature data, humidity data, mobile device motion state data, ambient sound level data, ambient illumination data, mobile device activation and/or deactivation data, and/or radio frequency (RF) measurement data for base stations and/or APs.

Environmental characteristics for one or more environments visited by the multiple devices are determined 520 based, at least in part, on one or more environmental rules applied to the measurement data. In some embodiments, at least one of the one or more environmental rules may have been determined based, at least in part, on previously acquired sensor measurement data representative of sensor measurements performed by one or more sensors of at least one mobile device, and on known environmental characteristics associated with at least one location at which the sensor measurements were performed. That is, environmental rules may be defined according to patterns associating measurement data with known environmental characteristics. In some embodiments, determination of environmental rules, using measurement data received for known environments, and/or determination of environmental characteristics, using determined environmental rules and measurement data received for unknown environments, may be performed with a learning engine implementation. Because application of multiple environmental rules to the measurement data may result in determination of inconsistent environmental characteristics, in some embodiments, the processor-based device may be configured to combine (e.g., through averaging or through some other operation or formulation) the computed environmental characteristics according to weights or probabilities associated with the different computed/derived environmental characteristics. Such weights or probabilities (which may be referred to as probability values) may be associated with the respective applied environmental rules and may be adjustable weights or probabilities that are computed/derived by the processor-based device based on a degree of fit between the measurement data and parameters defining the respective applied environmental rules. As noted, in some embodiments, the determined environmental characteristics may be stored at the processor-based device and/or may be used to construct environmental characteristic maps representative of the characteristics of the environments at which the mobile devices are located. Data including or based on at least some of the determined environmental characteristics data may be communicated to one or more of the mobile devices. Such data may include, for example, map data, navigation data and/or data related to a specific environment such as weather and/or traffic data for an outdoor environment or travel related data for an airport, railway station or bus station. In an embodiment, map data communicated to one or more of the mobile devices may comprise environmental characteristic maps generated based, at least in part, on the environmental characteristics determined from the measurement data transmitted by the mobile device to the remote processor-based device

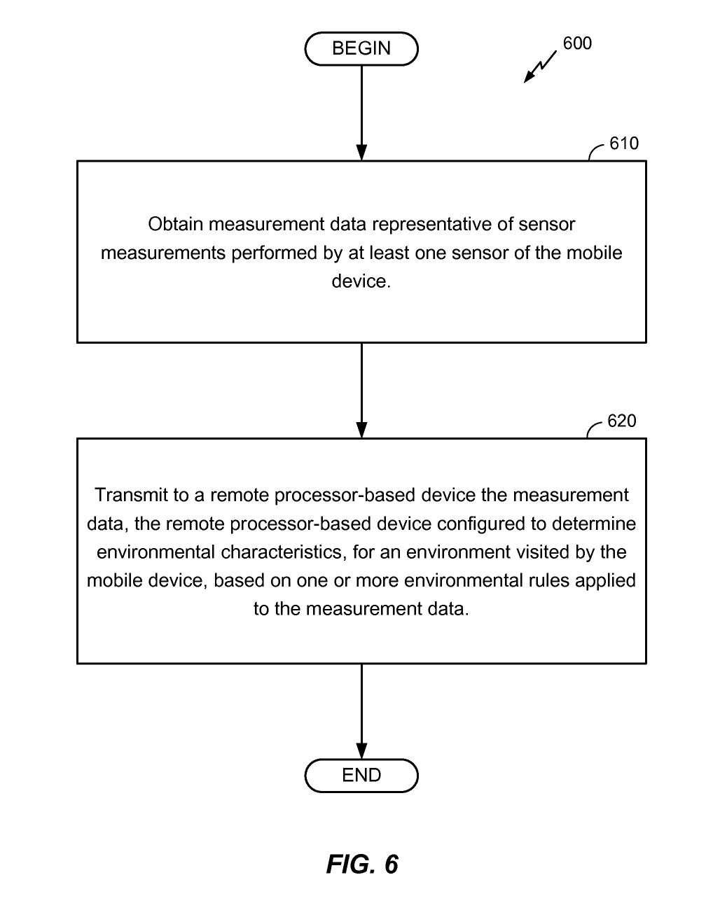

With reference next to FIG. 6, a flowchart of an example procedure 600, generally performed at a mobile device, to facilitate environmental characteristics determination is shown. The procedure may be performed by a mobile device corresponding to any of mobile devices 130 in FIG. 1, mobile device 206 or 208 in FIG. 2, or mobile device 300 in FIG. 3. The procedure 600 includes obtaining 610 measurement data representative of sensor measurements performed by at least one sensor of the mobile device. The measurement data obtained by the mobile device is then transmitted 620 to a remote processor-based device (e.g., a server, such as the server 110 of FIG. 1 or the server 202 of FIG. 2), with the remote processor-based device being configured to determine environmental characteristics, for an environment visited by the mobile device, based on one or more environmental rules applied to the measurement data. In some embodiments, the mobile device may receive from the remote processor-based device data representative of or related to at least some environmental characteristics for the environment visited by the mobile device, such as control data or navigation instructions for the environment visited by the mobile device or map data or data for a specific environment such as weather and/or traffic data for an outdoor environment or travel related data for an airport, railway station or bus station.

In some embodiments, the one or more environmental rules applied to the measurement data by the remote processor-based device at 620 may be determined by the remote processor-based device based, at least in part, on previously acquired sensor measurement data, received at the remote processor-based device, representative of sensor measurements performed by one or more sensors of at least one mobile device, and on known environmental characteristics associated with at least one location at which the sensor measurements by the one or more sensors of the at least one mobile device were performed.

In some embodiments, the mobile device may obtain additional data pertinent to a current location of the mobile device at 610 such as: (i) an estimate of this location; (ii) measurements of base stations, APs and/or SPS satellites that may enable the remote processor-based device receiving the additional pertinent data to compute a current location for the mobile device; and/or (iii) the current date and time. The mobile device may then transmit this additional pertinent data along with the sensor measurement data to the remote processor-based device at 620. In some embodiments, the mobile device may first store the measurement data and any additional pertinent data obtained at 610 and transmit the stored measurement data and any additional pertinent data to the remote processor-based device at 620 at some later time—which may occur in some embodiments a few hours, days or weeks after the data was obtained at 610. In some embodiments, the measurement data and any additional pertinent data transmitted at 620 may enable the remote processor-based device to infer or determine environmental rules (e.g. that may be used at a later time by the remote processor-based device to infer environmental characteristics) when the environment or environmental characteristics for the mobile device are already known to the remote processor-based device (e.g. based on a known location or known environment referred to in, or determined from, the measurement data and any additional pertinent data transmitted at 620).

The procedures and techniques described herein for inferring environmental characteristics from received sensor based measurements made at unknown or partially unknown environments, and for determining, validating or updating environmental rules from received sensor based measurements made at known environments, generally assume that mobile devices (e.g. mobile devices such as 130, 206, 208 and 300) provide the sensor based measurements and that a server (e.g. server 110, 202 or 400) performs the determination of environmental characteristics and/or the determination, validation and/or updating of environmental rules. However, in some embodiments, these roles may be performed by other entities. For example, access points and/or base stations may be configured to provide sensor based measurements to another processor-based entity (e.g. a server 110 or 202) to enable that processor-based entity to determine environmental characteristics and/or environmental rules. In that case, an access point or base station may perform similar functions or the same functions as those described herein for a mobile device—e.g. a mobile device 130, the mobile device 206 or 208 or a mobile device that performs the example procedure 600 of FIG. 6. In addition or alternatively, an access point (e.g. an AP 120), base station (e.g. base station 150) or a mobile device (e.g. a mobile device 130, 206, 208 or 300) may perform similar functions or the same functions as those described herein for a server—e.g. the server 110, 202 or a server that performs the example procedure 500 of FIG. 5. In this case, the access point, base station or mobile device that performs the similar or same functions as a server may obtain sensor based measurements from inbuilt sensors or nearby sensors that are attached or accessible via some communications link. The sensor based measurements may be obtained at different times to enable a mobile device to infer environmental characteristics for different locations that are visited by the mobile device and/or to determine environmental rules using sensors based measurements obtained when the mobile device is in some known environment (or an environment with some known environmental characteristics). Similarly, an access point or base station may obtain sensor based measurements at different times (e.g. at different times of day and/or different days in the week) to improve determination of environmental characteristics for a possible fixed location of the access point or base station and/or to enable determination of one or more environmental rules when a base station or access point is in a known environment. A mobile device, access point or base station that infers environmental characteristics and/or determines environmental rules may also receive sensor based measurements from other devices (e.g. other mobile devices, access points and/or base stations) to enable determination of environmental characteristics for the locations of these access points, base stations and/or mobile devices, and/or to enable determination of additional environmental rules. In some embodiments, mobile stations acting as receivers of sensors based measurements and/or as providers of sensor based measurements may exchange the sensor based measurements (and possibly additional pertinent data) using peer to peer signaling.

Performing the procedures described herein may be facilitated by a processor-based computing system. With reference to FIG. 7, a schematic diagram of an example computing system 700 is shown. The computing system 700 may be housed in, for example, a handheld mobile device such as the devices 130a-g, 206, 208, and 300 of FIGS. 1, 2, and 3, or may comprise part or all of servers 110, 202 and 400 depicted in FIGS. 1, 2 and 4. The computing system 700 includes a computing-based device 710 such as a personal computer, a specialized computing device, a controller, and so forth, that typically includes a central processor unit (CPU) 712. In addition to the CPU 712, the system includes main memory, cache memory and bus interface circuits (not shown). The computing-based device 710 may include a mass storage device 714, such as a hard drive and/or a flash drive associated with the computer system. The computing system 700 may further include a keyboard, or keypad, 716, and a monitor 720, e.g., a CRT (cathode ray tube) or LCD (liquid crystal display) monitor, that may be placed where a user can access them (e.g., a mobile device's screen).

The computing-based device 710 is configured to facilitate, for example, the implementation of the procedures described herein. The mass storage device 714 may thus include a computer program product that when executed on the computing-based device 710 causes the computing-based device to perform operations to facilitate the implementation of the procedures described herein. The computing-based device may further include peripheral devices to enable input/output functionality. Such peripheral devices may include, for example, a CD-ROM drive and/or flash drive, or a network connection, for downloading related content to the connected system. Such peripheral devices may also be used for downloading software containing computer instructions to enable general operation of the respective system/device. Alternatively and/or additionally, in some embodiments, special purpose logic circuitry, e.g., an FPGA (field programmable gate array), a DSP processor, or an ASIC (application-specific integrated circuit) may be used in the implementation of the computing system 700. Other modules that may be included with the computing-based device 710 are speakers, a sound card, a pointing device, e.g., a mouse or a trackball, by which the user can provide input to the computing system 700. The computing-based device 710 may include an operating system.

Computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal.

Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although particular embodiments have been disclosed herein in detail, this has been done by way of example for purposes of illustration only, and is not intended to be limiting with respect to the scope of the appended claims, which follow. In particular, it is contemplated that various substitutions, alterations, and modifications may be made without departing from the spirit and scope of the invention as defined by the claims. Other aspects, advantages, and modifications are considered to be within the scope of the following claims. The claims presented are representative of the embodiments and features disclosed herein. Other unclaimed embodiments and features are also contemplated. Accordingly, other embodiments are within the scope of the following claims.

What is claimed is:

1. A method comprising, at a processor-based device:
receiving from multiple mobile devices measurement data representative of sensor measurements performed by at least one sensor of each of the multiple mobile devices; and
determining environmental characteristics for one or more environments visited by the multiple mobile devices based, at least in part, on one or more environmental rules applied to the measurement data.

2. The method of claim 1, further comprising, at the processor-based device:
determining at least one of the one or more environmental rules based, at least in part, on previously acquired sensor measurement data representative of sensor measurements performed by one or more sensors of at least one mobile device, and on known environmental characteristics associated with at least one location at which the sensor measurements by the one or more sensors of the at least one mobile device were performed.

3. The method of claim 2, wherein the at least one of the one or more environmental rules are determined based further on one or more of: geographical information associated with the at least one location, or temporal information associated with date and time at which the sensor measurements by the one or more sensors of the at least one mobile device were performed.

4. The method of claim 1, wherein the measurement data comprises one or more of: barometric pressure data, temperature data, humidity data, mobile device motion state data, ambient sound level data, ambient illumination data, mobile device activation and deactivation data, or radio frequency (RF) measurement data.

5. The method of claim 1, wherein determining the environmental characteristics comprises:
computing candidate environmental characteristics and associated weights resulting from application of each of the one or more environmental rules to at least a portion of the measurement data; and
combining the candidate environmental characteristics based on the weights to compute an environmental characteristic based on the combined candidate environmental characteristics.

6. The method of claim 5, further comprising, at the processor-based device:
computing the weights based on a degree of fit between the measurement data and parameters defining the respective applied one or more environmental rules.

7. The method of claim 5, further comprising, at the processor-based device:
partitioning an area of interest into a plurality of partitioned areas;
obtaining local candidate environmental characteristics for each partitioned area of the plurality of partitioned areas based, at least in part, on measurement data representing sensor measurements performed by mobile devices while visiting each partitioned area; and
determining a probable set of environmental characteristics for the plurality of partitioned areas based, at least in part, on at least one rule providing correlations between local candidate environmental characteristics in two or more nearby partitioned areas in the plurality of partitioned areas.

8. The method of claim 7, wherein a respective size of each partitioned area from the plurality of partitioned areas is adjusted to achieve an equal or similar number of mobile devices providing measurement data representing sensor measurements for each partitioned area.

9. The method of claim 1, further comprising, at the processor-based device:
determining one or more categories of environmental characteristics for one or more locations visited by the multiple mobile devices based, at least in part, on one or more environmental category rules applied to the measurement data.

10. The method of claim 9, further comprising, at the processor-based device:
determining one or more specific environments or specific environmental characteristics based at least in part on the determined categories of environmental characteristics.

11. The method of claim 1, further comprising, at the processor-based device:
communicating, to at least one mobile device, navigation data determined based, at least in part, on at least one of the environmental characteristics determined from the measurement data, the navigation data comprising one or more of: map data for a particular environment, data for one or more environmental characteristics for the particular environment, or navigation instructions corresponding to the particular environment.

12. The method of claim 1, further comprising:
selecting from a set of environmental rules, based, at least in part, on the measurement data, the one or more environmental rules to apply to the measurement data.

13. The method of claim 1, further comprising:
generating one or more environmental characteristic maps for the one or more environments visited by the multiple mobile devices based, at least in part, on the environmental characteristics determined from the measurement data.

14. A device comprising:
one or more processors; and
storage media comprising computer instructions that, when executed on the one or more processors, cause operations comprising:
receiving from multiple mobile devices, at the device, measurement data representative of sensor measurements performed by at least one sensor of each of the multiple mobile devices; and
determining environmental characteristics for one or more environments visited by the multiple mobile devices based, at least in part, on one or more environmental rules applied to the measurement data.

15. The device of claim 14, wherein the storage media comprises further computer instructions to cause further operations comprising:
determining at least one of the one or more environmental rules based, at least in part, on previously acquired sensor measurement data representative of sensor measurements performed by one or more sensors of at least one mobile device, and on known environmental characteristics associated with at least one location at which the sensor measurements by the one or more sensors of the at least one mobile device were performed.

16. The device of claim 14, wherein the measurement data comprises one or more of: barometric pressure data, temperature data, humidity data, mobile device motion state data, ambient sound level data, ambient illumination data, mobile device activation and deactivation data, or radio frequency (RF) measurement data.

17. The device of claim 14, wherein determining the environmental characteristics comprises:
computing candidate environmental characteristics and associated weights resulting from application of each of the one or more environmental rules to at least a portion of the measurement data; and
combining the candidate environmental characteristics based on the weights to compute an environmental characteristic based on the combined candidate environmental characteristics.

18. The device of claim 17, wherein the storage media comprises further computer instructions to cause further operations comprising:
computing the weights based on degree of fit between the measurement data and parameters defining the respective applied one or more environmental rules.

19. The device of claim 17, wherein the storage media comprises further computer instructions to cause further operations comprising:
partitioning an area of interest into a plurality of partitioned areas;
obtaining local candidate environmental characteristics for each partitioned area of the plurality of partitioned areas based, at least in part, on measurement data representing sensor measurements performed by mobile devices while visiting each partitioned area; and
determining a probable set of environmental characteristics for the plurality of partitioned areas based, at least in part, on at least one rule providing correlations between local candidate environmental characteristics in two or more nearby partitioned areas in the plurality of partitioned areas.

20. The device of claim 19, wherein a respective size of each partitioned area from the plurality of partitioned areas is adjusted to achieve an equal or similar number of mobile devices providing measurement data representing sensor measurements for each partitioned area.

21. The device of claim 14, wherein the storage media comprises further computer instructions to cause further operations comprising:
communicating, to at least one mobile device, navigation data determined based, at least in part, on at least one of the environmental characteristics determined from the measurement data, the navigation data comprising one or more of: map data for a particular environment, data for one or more environmental characteristics for the particular environment, or navigation instructions corresponding to the particular environment.

22. The device of claim 14, wherein the storage media comprises further computer instructions to cause further operations comprising:
generating one or more environmental characteristic maps for the one or more environments visited by the multiple mobile devices based, at least in part, on the environmental characteristics determined from the measurement data.

23. An apparatus comprising:
means for receiving from multiple mobile devices measurement data representative of sensor measurements performed by at least one sensor of each of the multiple mobile devices; and
means for determining environmental characteristics for one or more environments visited by the multiple mobile devices based, at least in part, on one or more environmental rules applied to the measurement data.

24. The apparatus of claim 23, further comprising:
means for determining at least one of the one or more environmental rules based, at least in part, on previously acquired sensor measurement data representative of sensor measurements performed by one or more sensors of at least one mobile device, and on known environmental characteristics associated with at least one location at which the sensor measurements by the one or more sensors of the at least one mobile device were performed.

25. The apparatus of claim 23, wherein the measurement data comprises one or more of: barometric pressure data, temperature data, humidity data, mobile device motion state data, ambient sound level data, ambient illumination data, mobile device activation and deactivation data, or radio frequency (RF) measurement data.

26. The apparatus of claim 23, wherein the means for determining the environmental characteristics comprises:
means for computing candidate environmental characteristics and associated weights resulting from application of each of the one or more environmental rules to at least a portion of the measurement data; and
means for combining the candidate environmental characteristics based on the weights to compute an environmental characteristic based on the combined candidate environmental characteristics.

27. The apparatus of claim 26, further comprising:
means for computing the weights based on degree of fit between the measurement data and parameters defining the respective applied one or more environmental rules.

28. The apparatus of claim 26, further comprising:
means for partitioning an area of interest into a plurality of partitioned areas;
means for obtaining local candidate environmental characteristics for each partitioned area of the plurality of partitioned areas based, at least in part, on measurement data representing sensor measurements performed by mobile devices while visiting each partitioned area; and
means for determining a probable set of environmental characteristics for the plurality of partitioned areas based, at least in part, on at least one rule providing correlations between local candidate environmental characteristics in two or more nearby partitioned areas in the plurality of partitioned areas.

29. The apparatus of claim 28, wherein a respective size of each partitioned area from the plurality of partitioned areas is adjusted to achieve an equal or similar number of mobile devices providing measurement data representing sensor measurements for each partitioned area.

30. The apparatus of claim 23, further comprising:
means for communicating, to at least one mobile device, navigation data determined based, at least in part, on at least one of the environmental characteristics determined from the measurement data, the navigation data comprising one or more of: map data for a particular environment, data for one or more environmental characteristics for the particular environment, or navigation instructions corresponding to the particular environment.

31. The apparatus of claim 23, further comprising:
means for generating one or more environmental characteristic maps for the one or more environments visited by the multiple mobile devices based, at least in part, on the environmental characteristics determined from the measurement data.

32. A processor readable media programmed with a set of instructions executable on a processor that, when executed, causes operations comprising:
receiving from multiple mobile devices measurement data representative of sensor measurements performed by at least one sensor of each of the multiple mobile devices; and
determining environmental characteristics for one or more environments visited by the multiple mobile devices based, at least in part, on one or more environmental rules applied to the measurement data.

33. The processor readable media of claim 32, wherein the set of instructions comprises further computer instructions to cause further operations comprising:
determining at least one of the one or more environmental rules based, at least in part, on previously acquired sensor measurement data representative of sensor measurements performed by one or more sensors of at least one mobile device, and on known environmental characteristics associated with at least one location at which the sensor measurements by the one or more sensors of the at least one mobile device were performed.

34. The processor readable media of claim 32, wherein the measurement data comprises one or more of: barometric pressure data, temperature data, humidity data, mobile device motion state data, ambient sound level data, ambient illumination data, mobile device activation and deactivation data, or radio frequency (RF) measurement data.

35. The processor readable media of claim 32, wherein determining the environmental characteristics comprises:
computing candidate environmental characteristics and associated weights resulting from application of each of the one or more environmental rules to at least a portion of the measurement data; and
combining the candidate environmental characteristics based on the weights to compute an environmental characteristic based on the combined candidate environmental characteristics.

36. The processor readable media of claim 35, wherein the set of instructions comprises further computer instructions to cause further operations comprising:
computing the weights based on degree of fit between the measurement data and parameters defining the respective applied one or more environmental rules.

37. The processor readable media of claim 35, wherein the set of instructions comprises further computer instructions to cause further operations comprising:
partitioning an area of interest into a plurality of partitioned areas;
obtaining local candidate environmental characteristics for each partitioned area of the plurality of partitioned areas based, at least in part, on measurement data representing sensor measurements performed by mobile devices while visiting each partitioned area; and
determining a probable set of environmental characteristics for the plurality of partitioned areas based, at least in part, on at least one rule providing correlations between local candidate environmental characteristics in two or more nearby partitioned areas in the plurality of partitioned areas.

38. The processor readable media of claim 37, wherein a respective size of each partitioned area from the plurality of partitioned areas is adjusted to achieve an equal or similar number of mobile devices providing measurement data representing sensor measurements for each partitioned area.

39. The processor readable media of claim 32, wherein the set of instructions comprises further computer instructions to cause further operations comprising:
communicating, to at least one mobile device, navigation data determined based, at least in part, on at least one of the environmental characteristics determined from the measurement data, the navigation data comprising one or more of: map data for a particular environment, data for one or more environmental characteristics for the particular environment, or navigation instructions corresponding to the particular environment.

40. The processor readable media of claim 32, wherein the set of instructions comprises further computer instructions to cause further operations comprising:
generating one or more environmental characteristic maps for the one or more environments visited by the multiple mobile devices based, at least in part, on the environmental characteristics determined from the measurement data.

41. A method comprising, at a processor-based mobile device:
obtaining measurement data representative of sensor measurements performed by at least one sensor of the mobile device; and
transmitting to a remote processor-based device the measurement data, the remote processor-based device configured to determine environmental characteristics for an environment visited by the mobile device, based at least in part on one or more environmental rules applied to the measurement data.

42. The method of claim 41, wherein at least one of the one or more environmental rules is determined based, at least in part, on previously acquired sensor measurement data, received at the remote processor-based device, representative of sensor measurements performed by one or more sensors of at least one mobile device, and on known environmental characteristics associated with at least one location at which the sensor measurements by the one or more sensors of the at least one mobile device were performed.

43. The method of claim 41, wherein the measurement data comprises one or more of: barometric pressure data, temperature data, humidity data, mobile device motion state data, ambient sound level data, ambient illumination data, mobile device activation and deactivation data, or radio frequency (RF) measurement data.

44. The method of claim 41, further comprising, at the mobile device:
receiving navigation data determined based, at least in part, on at least one of the environmental characteristics, the navigation data comprising one or more of: data for the environment visited by the mobile device, or navigation data corresponding to the environment visited by the mobile device.

45. The method of claim 44, wherein receiving the navigation data comprises:
receiving at least a portion of one or more environmental characteristic maps generated based, at least in part, on the environmental characteristics determined from the measurement data transmitted by the mobile device to the remote device.

46. A mobile device comprising:
one or more processors;
at least one sensor; and
storage media comprising computer instructions that, when executed on the one or more processors, cause operations comprising:
obtaining measurement data representative of sensor measurements performed by the at least one sensor of the mobile device; and
transmitting to a remote processor-based device the measurement data, the remote processor-based device configured to determine environmental characteristics, for an environment visited by the mobile device, based, at least in part, on one or more environmental rules applied to the measurement data.

47. The device of claim 46, wherein at least one of the one or more environmental rules is determined based, at least in part, on previously acquired sensor measurement data, received at the remote processor-based device, representative of sensor measurements performed by one or more sensors of at least one mobile device, and on known environmental characteristics associated with at least one location at which the sensor measurements by the one or more sensors of the at least one mobile device were performed.

48. The device of claim 46, wherein the measurement data comprises one or more of: barometric pressure data, temperature data, humidity data, mobile device motion state data, ambient sound level data, ambient illumination data, mobile device activation and deactivation data, or radio frequency (RF) measurement data.

49. The device of claim 46, wherein the storage media comprises further computer instructions to cause further operations comprising:
receiving navigation data determined based, at least in part, on at least one of the environmental characteristics determined by the remote processor-based device, the navigation data comprising one or more of: map data for the environment visited by the mobile device, data for one or more environmental characteristics for the environment visited by the mobile device, or navigation instructions corresponding to the environment visited by the mobile device.

50. The device of claim 49, wherein receiving the navigation data comprises:
receiving at least a portion of one or more environmental characteristic maps generated based, at least in part, on the environmental characteristics determined from the measurement data transmitted by the mobile device to the remote processor-based device.

51. An apparatus comprising:
means for obtaining measurement data representative of sensor measurements performed by at least one sensor of a mobile device; and
means for transmitting to a remote processor-based device the measurement data, the remote processor-based device configured to determine environmental characteristics, for an environment visited by the mobile device, based on one or more environmental rules applied to the measurement data.

52. The apparatus of claim 51, wherein at least one of the one or more environmental rules is determined based, at least in part, on previously acquired sensor measurement data, received at the remote processor-based device, representative of sensor measurements performed by one or more sensors of at least one mobile device, and on known environmental characteristics associated with at least one location at which the sensor measurements by the one or more sensors of the at least one mobile device were performed.

53. The apparatus of claim 51, wherein the measurement data comprises one or more of: barometric pressure data, temperature data, humidity data, mobile device motion state data, ambient sound level data, ambient illumination data, mobile device activation and deactivation data, or radio frequency (RF) measurement data.

54. The apparatus of claim 51, further comprising:
means for receiving navigation data determined based, at least in part, on at least one of the environmental characteristics determined by the remote processor-based device, the navigation data comprising one or more of: map data for the environment visited by the mobile device, data for one or more environmental characteristics for the environment visited by the mobile device, or navigation instructions corresponding to the environment visited by the mobile device.

55. The apparatus of claim 54, wherein the means for receiving the navigation data comprises:
means for receiving at least a portion of one or more environmental characteristic maps generated based, at least in part, on the environmental characteristics determined from the measurement data transmitted by the mobile device to the remote processor-based device.

56. A processor readable media programmed with a set of instructions executable on a processor that, when executed, causes operations comprising:
obtaining measurement data representative of sensor measurements performed by at least one sensor of a mobile device; and
transmitting to a remote processor-based device the measurement data, the remote processor-based device configured to determine environmental characteristics, for an environment visited by the mobile device, based on one or more environmental rules applied to the measurement data.

57. The processor readable media of claim 56, wherein at least one of the one or more environmental rules is determined based, at least in part, on previously acquired sensor measurement data, received at the remote processor-based device, representative of sensor measurements performed by one or more sensors of at least one mobile device, and on known environmental characteristics associated with at least one location at which the sensor measurements by the one or more sensors of the at least one mobile device were performed.

58. The processor readable media of claim 56, wherein the measurement data comprises one or more of: barometric pressure data, temperature data, humidity data, mobile device motion state data, ambient sound level data, ambient illumination data, mobile device activation and deactivation data, or radio frequency (RF) measurement data.

59. The processor readable media of claim 56, wherein the set of instructions comprises further computer instructions to cause further operations comprising:
receiving navigation data determined based, at least in part, on at least one of the environmental characteristics determined by the remote processor-based device, the navigation data comprising one or more of: map data for the environment visited by the mobile device, data for one or more environmental characteristics for the environment visited by the mobile device, or navigation instructions corresponding to the environment visited by the mobile device.

60. The processor readable media of claim 59, wherein receiving the navigation data comprises:
receiving at least a portion of one or more environmental characteristic maps generated based, at least in part, on the environmental characteristics determined from the measurement data transmitted by the mobile device to the remote processor-based device.
